(19) United States
(12) Patent Application Publication
(10) Pub. No.: US 2025/0125451 A1
(43) Pub. Date: Apr. 17, 2025

(54) METAL AIR ELECTROCHEMICAL CELL ARCHITECTURE

(71) Applicant: FORM ENERGY, INC., Somerville, MA (US)

(72) Inventors: Jarrod David MILSHTEIN, Cambridge, MA (US); Mitchell Terrance WESTWOOD, Boston, MA (US); William Henry WOODFORD, Cambridge, MA (US); Yet-Ming CHIANG, Weston, MA (US); Mateo Cristian JARAMILLO, San Francisco, CA (US); Ian Salmon MCKAY, Seattle, WA (US); Rachel Elizabeth MUMMA, Somerville, MA (US); Eric WEBER, Pittsburgh, PA (US); Liang SU, Medford, MA (US); Amelie Nina KHAREY, Cambridge, MA (US); Marco FERRARA, Boston, MA (US); Theodore Alan WILEY, Somerville, MA (US)

(21) Appl. No.: 18/988,337

(22) Filed: Dec. 19, 2024

Related U.S. Application Data
(62) Division of application No. 16/456,860, filed on Jun. 28, 2019.
(60) Provisional application No. 62/692,400, filed on Jun. 29, 2018.

(51) Int. Cl. H01M 12/02; H01M 12/08; H01M 50/609

(52) U.S. Cl. CPC H01M 12/02; H01M 12/08; H01M 50/609

(57) ABSTRACT

Systems and methods of the various embodiments may provide metal air electrochemical cell architectures. Various embodiments may provide a battery, such as an unsealed battery or sealed battery, with an open cell arrangement configured such that a liquid electrolyte layer separates a metal electrode from an air electrode. In various embodiments, the electrolyte may be disposed within one or more vessel of the battery such that electrolyte serves as a barrier between a metal electrode and gaseous oxygen. Systems and methods of the various embodiments may provide for removing a metal electrode from electrolyte to prevent self-discharge of the metal electrode. Systems and methods of the various embodiments may provide a three electrode battery configured to operate each in a discharge mode, but with two distinct electrochemical reactions occurring at each electrode.

### RELATED APPLICATIONS

This application is a divisional of U.S. patent application Ser. No. 16/456,860 entitled “METAL AIR ELECTROCHEMICAL CELL ARCHITECTURE” filed Jun. 28, 2019, which claims the benefit of priority to U.S. Provisional Patent Application 62/692,400 entitled “Unsealed Metal Air Electrochemical Cell Architecture” filed Jun. 29, 2018, with the entire contents of each of these applications hereby incorporated herein by reference. This application is related to U.S. patent application Ser. No. 16/456,571 entitled “Aqueous Polysulfide-Based Electrochemical Cell” filed Jun. 28, 2019, and this application is related to U.S. patent application Ser. No. 16/457,253 entitled “Rolling Diaphragm Seal” filed Jun. 28, 2019. The entire contents of both related applications are hereby incorporated by reference for all purposes.

### BACKGROUND

Batteries sealed off from the environment, i.e., sealed batteries, come with significant challenges. For example, the architecture elements of sealed batteries, such as current collectors, require feedthrough passages in the battery walls that require their own seals and represent likely failure and leakage points. Unsealed batteries, i.e., batteries open to the environment, may overcome some of the challenges of sealed batteries.

Energy storage technologies, such as battery-based energy storage technologies, are playing an increasingly important role in electric power grids. At a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultra-long duration (collectively, at least ≥8 h) energy storage systems. Improved architecture elements of batteries, such as sealed and/or unsealed batteries, are needed long duration energy storage (LODES) systems.

This Background section is intended to introduce various aspects of the art, which may be associated with embodiments of the present inventions. Thus, the foregoing discussion in this section provides a framework for better understanding the present inventions, and is not to be viewed as an admission of prior art.

### SUMMARY

Systems and methods of the various embodiments may provide metal air electrochemical cell architectures, such as sealed metal air electrochemical cell architectures, unsealed metal air electrochemical cell architectures, etc. Various embodiments may provide a battery, such as a sealed or unsealed battery, with an open cell arrangement configured such that a liquid electrolyte layer separates a metal electrode from an air electrode. In various embodiments, the electrolyte may be disposed within one or more vessel of the battery such that electrolyte serves as a barrier between a metal electrode and gaseous oxygen.

Various embodiments may include a battery having a first vessel, such as a vessel open to an air environment or a vessel that may be sealed, a first air electrode, a first metal electrode, and a first volume of liquid electrolyte within the first vessel. The first volume of liquid electrolyte may separate the first air electrode from the first metal electrode. Additionally, the first volume of liquid electrolyte may form a barrier between the first metal electrode and oxygen from the gas environment (e.g., the air environment) accessible via the unsealed first vessel or retained within the sealed first vessel itself.

Systems and methods of the various embodiments may provide for removing a metal electrode from the electrolyte to prevent self-discharge of the metal electrode. In various embodiments, a pump may pump liquid electrolyte into and out of a vessel of a battery such that the metal electrode is submerged in the liquid electrolyte when the liquid electrolyte is pumped into the vessel and the metal electrode is removed from the liquid electrolyte when the liquid electrolyte is pumped out of the vessel. In various embodiments, a gas filled bladder may be inflated and deflated to displace the liquid electrolyte such that the metal electrode is submerged in the liquid electrolyte when the gas bladder is inflated and the metal electrode is removed from the liquid electrolyte when the gas bladder is deflated. In various embodiments, one or more lifting systems may raise and lower the metal electrode out of and into the liquid electrolyte.

Systems and methods of the various embodiments may provide a three electrode battery configured to operate each in a discharge mode, but with two distinct electrochemical reactions occurring at each electrode. The second electrode may be used to fully oxidize a partially reacted species or may be used to oxidize a species generated by a spontaneous chemical reaction in the cell that is not otherwise controlled by the first electrode. In various embodiments, the electrolyte of the battery may flood a surface of one electrode when the battery is operating in a discharge mode and the electrolyte may not flood the surface of that electrode when the battery is operating in a recharge mode.

Various embodiments may provide a battery, comprising: a first vessel; a first air electrode; a first metal electrode; and a first volume of liquid electrolyte within the first vessel, wherein the first volume of liquid electrolyte separates the first air electrode from the first metal electrode and the first volume of liquid electrolyte forms a barrier between the first metal electrode and oxygen from an air environment. In various embodiments, the air environment is trapped within the first vessel. In various embodiments, the first vessel is open to the air environment. In various embodiments, the battery may further comprise a second vessel; and a second metal electrode, wherein the first volume of liquid electrolyte separates the first air electrode from the second metal electrode and the first volume of liquid electrolyte forms a barrier between the second metal electrode and oxygen from the air environment. In various embodiments, the battery may further comprise one or more additional vessels; one or more additional air electrodes; one or more additional metal electrodes; and one or more additional volumes of liquid electrolyte, each additional volume of liquid electrolyte within its own respective one of the additional vessels, wherein each additional volume of liquid electrolyte separates a respective one of the additional air electrodes from a respective one of the additional metal electrodes. In various embodiments, the air electrodes are connected together in series and the metal electrodes are connected together in series. In various embodiments, the liquid electrolyte has a low solubility of oxygen. In various embodiments, the battery may further comprise a filter configured to filter out one or both of carbon dioxide from the liquid electrolyte and carbonate from the liquid electrolyte. In various embodiments, the first air electrode is configured to operate in both an oxygen evolution reaction mode and an oxygen reduction reaction mode. In various embodiments, the first air electrode comprises: a first electrode configured to operate in an oxygen evolution reaction mode; and a second electrode configured to operate in an oxygen reduction reaction mode. In various embodiments, the battery may further comprise a mechanical barrier configured to block oxygen bubbles from the first metal electrode when the battery is operating in a charging mode. In various embodiments, the mechanical barrier comprises Polybenzimidazole (PBI), polyethylene (PE), polypropylene (PP), polyvinylidene fluoride (PVDF), polytetrafluoroethylene (PTFE), cotton, rayon, or cellulose acetate. In various embodiments, the mechanical barrier is woven, non-woven, or felted.

Various embodiments may provide a battery, comprising: a vessel; an air electrode; a metal electrode; a rigid porous current collector supporting the metal electrode within the vessel; a liquid electrolyte within a portion of the vessel; and a pump fluidically coupled to the vessel, the pump configured to pump the liquid electrolyte into and out of the vessel such that the metal electrode is submerged in the liquid electrolyte when the liquid electrolyte is pumped into the vessel to a first level and the metal electrode is removed from the liquid electrolyte when the liquid electrolyte is pumped out of the vessel to a second level. In various embodiments, the metal electrode is comprised of iron or an iron-alloy.

Various embodiments may provide a battery comprising: a vessel; an air electrode; a metal electrode; a rigid porous current collector supporting the metal electrode within the vessel; a liquid electrolyte within a portion of the vessel; and a gas filled bladder, the gas filled bladder configured to displace the liquid electrolyte such that the metal electrode is submerged in the liquid electrolyte when the gas bladder is inflated to a first size and the metal electrode is removed from the liquid electrolyte when the gas bladder is deflated to a second size. In various embodiments, the gas bladder is an air bladder. In various embodiments, the metal electrode is comprised of iron or an iron-alloy

Various embodiments may provide a battery comprising: a vessel; an air electrode; a metal electrode; a rigid porous current collector supporting the metal electrode and the air electrode within the vessel; a liquid electrolyte within a portion of the vessel; and one or more lifting system coupled to the rigid porous current collector, the lifting system configured to raise and lower the metal electrode out of and into the liquid electrolyte.

In various embodiments, the lifting system comprises: one or more motors; and one or more drive elements coupled to the one or more motors. In various embodiments, the one or more drive elements are chains, belts, screws, or gears. In various embodiments, the metal electrode is comprised of iron or an iron-alloy.

Various embodiments may provide a battery, comprising: an anode; a first cathode; a second cathode; and an electrolyte, wherein the electrolyte floods a surface of the anode, a surface of the first cathode, and a surface of the second cathode when the battery is operating in a discharge mode and the electrolyte does not contact the second cathode when the battery is operating in a recharge mode. In various embodiments, the first cathode is configured to evolve oxygen in the recharge mode and to reduce oxygen in the discharge mode. In various embodiments, the anode is comprised of iron or an iron-alloy. In various embodiments, the first cathode comprises a hydrophilic portion and a hydrophobic portion. In various embodiments, the surface of the second cathode is hydrophilic. In various embodiments, the second cathode comprises a substrate coated with nickel. In various embodiments, the substrate comprises carbon, titanium, or copper. In various embodiments, the anode comprises iron ore in a form comprising taconite, magnetite, or hematite, reduced iron ore comprising iron metal (Fe0), wustite (FeO), or a mixture thereof, or reduced taconite, direct reduced (“DR”) taconite, not-yet-reduced “DR Grade” taconite, direct reduced iron (“DRI”), or any combination thereof. In various embodiments, the iron ore or reduced iron ore comprises pellets.

Various embodiments may provide a method of operating a battery comprising an anode, a first cathode and a second cathode, the method comprising: flooding a surface of the anode, a surface of the first cathode, and a surface of the second cathode with an electrolyte when the battery is operating in a discharge mode; and lowering an electrolyte level such that the electrolyte does not contact the second cathode when the battery is operating in a recharge mode. In various embodiments, the first cathode evolves oxygen in the recharge mode and reduces oxygen in the discharge mode, and the second electrolyte oxidizes hydrogen in the recharge mode and reduces hydrogen in the discharge mode.

Various embodiments may include a method for operating a battery, comprising: operating the battery in a first operating state in which a metal electrode is submerged in a liquid electrolyte; and operating the battery in a second operating state in which the metal electrode is removed from the liquid electrolyte. In various embodiments, the metal electrode is removed from the liquid electrolyte by reducing a level of the liquid electrolyte in the battery. In various embodiments, the level is reduced by pumping electrolyte out of the battery. In various embodiments, the level is reduced by deflating a gas filled bladder within the battery. In various embodiments, the metal electrode is removed from the liquid electrolyte by lifting the metal electrode out of the liquid electrolyte.

Various embodiments may provide a bulk energy storage system, comprising: one or more batteries, wherein at least one of the one or more batteries comprises: a first vessel; a first air electrode; a first metal electrode; and a first volume of liquid electrolyte within the first vessel, wherein the first volume of liquid electrolyte separates the first air electrode from the first metal electrode and the first volume of liquid electrolyte forms a barrier between the first metal electrode and oxygen from an air environment. In various embodiments, the first air electrode is configured to operate in both an oxygen evolution reaction mode and an oxygen reduction reaction mode. In various embodiments, the first air electrode comprises: a first electrode configured to operate in an oxygen evolution reaction mode; and a second electrode configured to operate in an oxygen reduction reaction mode. In various embodiments, the at least one of the one or more batteries further comprises: a mechanical barrier configured to block oxygen bubbles from the first metal electrode when the battery is operating in a charging mode. In various embodiments, the bulk energy storage system is a long duration energy storage (LODES) system.

Various embodiments may provide a bulk energy storage system, comprising: one or more batteries, wherein at least one of the one or more batteries comprises: an anode; a first cathode; a second cathode; and an electrolyte, wherein the electrolyte floods a surface of the anode, a surface of the first cathode, and a surface of the second cathode when the battery is operating in a discharge mode and the electrolyte does not contact the second cathode when the battery is operating in a recharge mode. In various embodiments, the first cathode is configured to evolve oxygen in the recharge mode and to reduce oxygen in the discharge mode. In various embodiments, the anode is comprised of iron or an iron-alloy. In various embodiments, the bulk energy storage system is a long duration energy storage (LODES) system.

Various embodiments may provide a bulk energy storage system, comprising: one or more batteries, wherein at least one of the one or more batteries comprises: a vessel; an air electrode; a metal electrode; a rigid porous current collector supporting the metal electrode within the vessel; a liquid electrolyte within a portion of the vessel; and a gas filled bladder, the gas filled bladder configured to displace the liquid electrolyte such that the metal electrode is submerged in the liquid electrolyte when the gas bladder is inflated to a first size and the metal electrode is removed from the liquid electrolyte when the gas bladder is deflated to a second size. In various embodiments, the gas bladder is an air bladder. In various embodiments, the metal electrode is comprised of iron or an iron-alloy. In various embodiments, the bulk energy storage system is a long duration energy storage (LODES) system.

Various embodiments may provide an electric battery comprising: an air electrode exposed to a gaseous oxygen containing environment, wherein the concentration of oxygen is at least about 15%; a metal electrode; and, an electrolyte, the electrolyte comprising a dissolved oxygen concentration of less than about 0.5 mol/L and having a carbonate level of less than about 8 mol/L. In various embodiments, the electrolyte is in ionic contact with the metal electrode. In various embodiments, the electrolyte is in ionic contact with the air electrode. In various embodiments, the electrolyte prevents parasitic discharging of the metal electrode. In various embodiments, the electrolyte provides an oxygen barrier for the metal electrode. In various embodiments, the gaseous environment is air. In various embodiments, the electrolyte covers the metal electrode. In various embodiments, the battery comprises a means to block oxygen bubbles.

Various embodiments may provide an electric battery having a first and a second configuration; the battery comprising: an air electrode; a metal electrode; and an electrolyte; wherein the first configuration comprises: the air electrode exposed to an oxygen containing environment; the electrolyte in ionic communication with both the air electrode and the metal electrode; the electrolyte comprising a dissolved oxygen concentration of less than about 0.5 mol/L and having a carbonate level of less than about 1 mol/L; the electrolyte covering the metal electrode and isolating the metal electrode from the oxygen containing environment; wherein the second configuration comprises: the air electrode exposed to an oxygen containing environment; the electrolyte not covering the metal electrode. In various embodiments, the metal electrode is exposed to the oxygen containing environment. In various embodiments, the carbonate concentration is less than about 5 mol/L. In various embodiments, the carbonate concentration is less than about 1 mol/L. In various embodiments, the carbonate concentration is less than about 0.1 mol/L. In various embodiments, the dissolved oxygen concentration is less than about 0.1 mol/L. In various embodiments, the dissolved oxygen concentration is less than about 0.01 mol/L. In various embodiments, the carbonate concentration is less than about 5 mol/L and the dissolved oxygen concentration is less than about 0.1 mol/L. In various embodiments, the carbonate concentration is less than about 1 mol/L and the dissolved oxygen concentration is less than about 0.1 mol/L. In various embodiments, the metal electrode comprises a component selected from the group consisting of iron, a bulk solid; a collection of particles; a suspension; particles that are not buoyant in the electrolyte; a metal mesh electrode; an iron mesh electrode; a metal felt electrode, an iron felt electrode; sintered metals; sintered iron; porous sintered metals; a porous bed of pellets, a gelled metal electrode; and a composite metal electrode formed from two or more different materials. In various embodiments, the active battery component comprises an electrolyte and a metal electrode, wherein the metal electrode comprises a component selected from the group consisting of a bed of direct reduced iron (DRI) pellets, and a bed of sponge iron pellets; and a bed of pellets comprising iron. In various embodiments, the active battery component comprises an electrolyte and a metal electrode, wherein the metal electrode comprises a component selected from the group consisting of a bed of direct reduced iron (DRI) pellets, and a bed of sponge iron pellets; and a bed of pellets comprising iron; and, wherein the carbonate concentration is less than about 5mol/L and the dissolved oxygen concentration is less than about 0.1 mol/L. In various embodiments, the active battery component comprises an electrolyte and a metal electrode, wherein the metal electrode comprises a component selected from the group consisting of a metal, a metal alloy, lithium (Li), sodium (Na), potassium (K), magnesium (Mg), calcium (Ca), silicon (Si), aluminum (Al), zinc (Zn), and iron (Fe). In various other embodiments the active components may include non-metallic solid active materials such as sulfur(S), sodium sulfide (Na2S), lithium sulfide (Li2S), potassium sulfide (K2S), iron sulfide (FeS or FeS2), manganese dioxide (MnO2), etc.

Various embodiments may provide an electrical system configured to manage the intermittencies in non-hydrocarbon based electricity generation to provide predetermined distribution of electricity, the electrical system comprising: a means to generate electricity from non-hydrocarbon energy sources; a bulk energy storage system comprising plurality of batteries, wherein the batteries comprise: an air electrode exposed to a gaseous oxygen containing environment, wherein the concentration of oxygen is at least about 15%; a metal electrode; and, an electrolyte, the electrolyte comprising a dissolved oxygen concentration of less than about 0.5 mol/L and having a carbonate level of less than about 8 mol/L; electrical power transmission facilities; the means to generate electricity from non-hydrocarbon energy sources, the batteries and the electrical power transmission facilities, in electrical communication, whereby electricity can be transmitted therebetween; and, the electrical system configured for electrical connection to a power grid, an industrial customer or both. In various embodiments, the means to generate electricity from non-hydrocarbon energy sources is selected from the group consisting of a wind farm, a thermal power plant, and a solar power plant. In various embodiments, the system includes a hydrocarbon based electrical power plant, an atomic energy based electric power plant, or both.

Various embodiments may include a method of operating an electrical system configured to manage intermittencies in non-hydrocarbon based electricity generation to provide predetermined distribution of electricity; the method comprising transferring electricity into a bulk energy storage system, storing the electricity in the bulk energy storage system, transferring the electricity out of the bulk energy storage system; wherein the electrical system comprises: a means to generate electricity from non-hydrocarbon energy sources; electrical power transmission facilities; the bulk energy storage system comprising a plurality of batteries, wherein the batteries comprise: an air electrode exposed to a gaseous oxygen containing environment, wherein the concentration of oxygen is at least about 15%; a metal electrode; and, an electrolyte, the electrolyte comprising a dissolved oxygen concentration of less than about 0.5 mol/L and having a carbonate level of less than about 8 mol/L; the means to generate electricity from non-hydrocarbon energy sources, the LODES and the electrical power transmission facilities, in electrical communication, whereby electricity can be transmitted therebetween; and, the electrical system configured for electrical connection to a power grid, an industrial customer or both.

Various embodiments may provide a system including a bulk energy storage system that is a LODES having a duration of about 24 hours to about 500 hours, and a power rating of from about 10 MW to about 50 MW. Various embodiments may provide a system including a bulk energy storage system that is a LODES having a duration of about 8 hours to about 2000 hours, and a power rating of from about 0.5 MW to about 500 MW. Various embodiments may provide a system including a bulk energy storage system that is a LODES having a duration of about 8 hours to about 100 hours, and a power rating of from about 0.5 MW to about 500 MW. Various embodiments may provide a system including a bulk energy storage system that is a LODES having a duration of about 24 hours to about 500 hours, and a power rating of from about 10 MW to about 50 MW. Various embodiments may provide a system including a bulk energy storage system that is a LODES having a duration of about 8 hours to about 2000 hours, and a power rating of from about 0.01MW to about 50,000 MW. Various embodiments may provide a system including a bulk energy storage system that is a LODES having a duration of about 8 hours to about 2000 hours, and a power rating of from about 0.5 MW to about 500 MW. Various embodiments may provide a system including a bulk energy storage system that is a LODES having a duration of about 50 hours to about 500 hours, and a power rating of from about 0.01MW to about 50,000 MW. Various embodiments may provide a system including a bulk energy storage system that is a LODES having a duration of about 24 hours to about 500 hours, and a power rating of from about 0.5 MW to about 500 MW. Various embodiments may provide a system including a bulk energy storage system that is a LODES having a duration of about 50 hours to about 1000 hours, and a power rating of from about 0.5 MW to about 1000 MW.

### BRIEF DESCRIPTION OF THE FIGURES

The accompanying drawings, which are incorporated herein and constitute part of this specification, illustrate example embodiments of the claims, and together with the general description given above and the detailed description given below, serve to explain the features of the claims.

FIG. 1 is a block diagram of an embodiment battery.

FIG. 2 is a block diagram of an embodiment multi-vessel battery.

FIG. 3 is a block diagram of a portion of an embodiment multi-vessel battery.

FIG. 4 is a block diagram of a portion of an embodiment multi-vessel battery.

FIG. 5 is a block diagram of an embodiment multi-vessel battery.

FIGS. 6A-8B are block diagrams of embodiment batteries showing operating states with metal electrodes submerged in or removed from liquid electrolytes.

FIGS. 9A, 9B, and 9C are block diagrams of an embodiment three electrode mechanically adjustable battery in a discharge mode and a recharge mode, respectively.

FIG. 10 is a block diagram of an embodiment battery.

FIGS. 11-19 illustrate various example systems in which one or more aspects of the various embodiments may be used as part of bulk energy storage systems.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the invention is not intended to limit the invention to these embodiments but rather to enable a person skilled in the art to make and use this invention.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Generally, the term “about” as used herein unless specified otherwise is meant to encompass a variance or range of ±10%, the experimental or instrument error associated with obtaining the stated value, and preferably the larger of these.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The following examples are provided to illustrate various embodiments of the present systems and methods of the present inventions. These examples are for illustrative purposes, may be prophetic, and should not be viewed as limiting, and do not otherwise limit the scope of the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular figure.

Embodiments of the present invention include apparatus, systems, and methods for long-duration, and ultra-long-duration, low-cost, energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage cells may refer to electrochemical cells that may be configured to store energy over time spans of days, weeks, or seasons. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

Unsealed batteries, i.e., batteries open to the environment, may overcome some of the challenges of sealed batteries. However, unsealed batteries, such as unsealed metal air batteries, may present challenges in minimizing the contact between metal electrodes and oxygen and in electrically insulating positive and negative electrodes while keeping the electrically-insulated electrodes in ionic contact

Various embodiments may provide a battery, such as an unsealed battery or a sealed battery, with an open cell arrangement configured such that a liquid electrolyte layer separates a metal electrode from an air electrode. In various embodiments, the electrolyte may be disposed within one or more vessel of the battery (e.g., the sealed battery, the unsealed battery, etc.) such that electrolyte serves as a barrier between a metal electrode and gaseous oxygen. In various embodiments, the battery may include a mechanical barrier, such as a membrane or porous separator, to serve as a barrier between a metal electrode and gaseous oxygen. In various embodiments, a metal electrode may be a solid or slurry metal electrode. In various embodiments, a metal electrode may be a metal mesh electrode, such as an iron mesh electrode. In various embodiments, a metal electrode may be a metal felt electrode, such as an iron felt electrode. In various embodiments, a metal electrode may be an electrode formed from sintered metals, such as sintered iron. In various embodiments, a metal electrode may be an electrode formed from porous sintered metals. In various embodiments, a metal electrode may be gelled metal electrode, such as a gelled iron electrode. In various embodiments, a metal electrode may be a composite metal electrode formed from two or more different materials, such as two or more different metals, a metal and one or more different metal and/or non-metal materials, etc. In various embodiments, a metal electrode may be a porous bed of pellets, such as a porous bed of metal pellets (e.g., a bed of direct reduced iron (DRI) pellets, a bed of sponge iron pellets, a bed of atomized iron powder, etc.). In various embodiments, the electrolyte layer may have an oxygen solubility that is sufficiently low to minimize contact between oxygen and the metal electrode. In various embodiments, effects of dissolved carbon dioxide in the electrolyte layer may be managed and/or mitigated. For example, scrubbing and/or filtration may be applied to the electrolyte layer to remove carbon dioxide from the electrolyte layer to maintain the carbon dioxide or carbonate ion (CO₃²⁻) level in the electrolyte layer within a certain range of concentrations. For example, the carbonate concentration may be maintained below a specified concentration; for example, the carbonate concentration may be maintained below about 1 mol/L. In certain other embodiments, the carbonate concentration may be maintained within a certain range of concentrations such as between about 0.5 mol/L and about 2 mol/L. In certain other embodiments the carbonate concentration may be maintained to be below about 0.5 mol/L.

In some embodiments, a mechanical barrier, such as a membrane or porous separator, may be used to physically block oxygen bubbles from contacting the metal electrode, such as oxygen bubbles from contacting the metal electrode when the battery is operating in a charging mode. In various embodiments, this mechanical barrier, such as a membrane or porous separator, may be a film or sheet of a polymer, such as Polybenzimidazole (PBI), polyethylene (PE), polypropylene (PP), polyvinylidene fluoride (PVDF), polytetrafluoroethylene (PTFE), or other polymers, or may be a natural fiber, such as cotton, rayon, or cellulose acetate. In various embodiments, the mechanical barrier, such as a membrane or porous separator, may be woven, non-woven, or felted. In various embodiments, a mechanical barrier, such as a membrane or porous separator, may have a porosity such as 50% by volume or greater, or 30% by volume or greater.

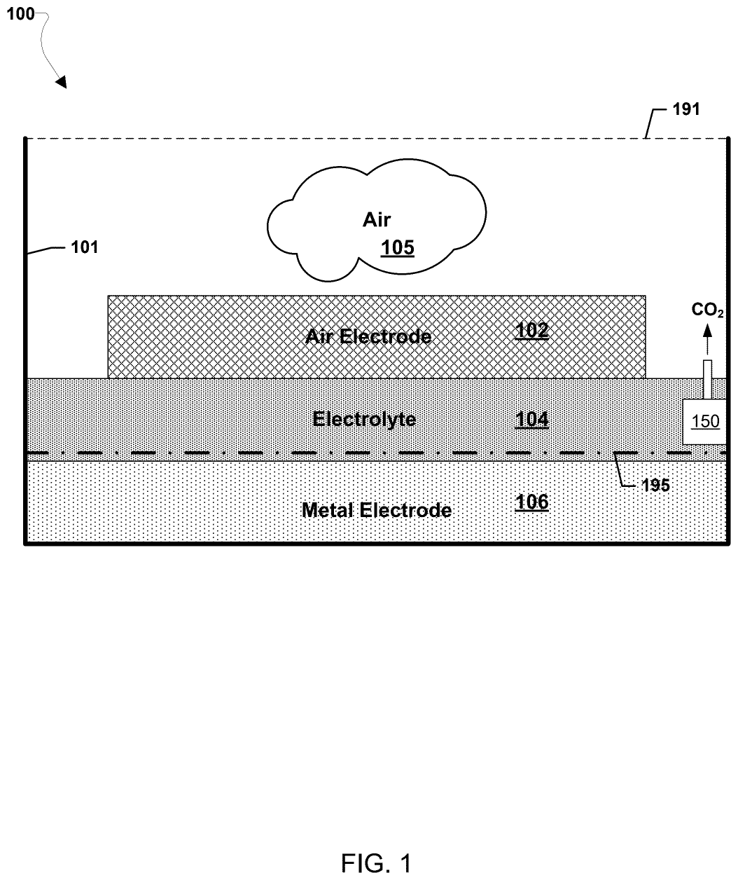

FIG. 1 is a block diagram of an embodiment battery 100 having an air electrode 102, volume of liquid electrolyte 104, and metal electrode 106 disposed in a vessel 101. In some embodiments, the battery 100 may be an unsealed battery open to the environment, such that air 105 passes freely into and out of the battery 100. In some optional embodiments, the battery 100 may be a sealed battery having a lid 191 (or other type containment structure) sealing off the vessel 101 from the environment. In such a sealed configuration, volumes of air 105 may be pumped into the vessel 101 and/or trapped in the vessel 101 itself by the lid 191 (or other type containment structure). When the battery 100 is an unsealed battery, the vessel 101 may be open to the air 105, i.e., an air environment, and the air electrode 102 may receive oxygen from the air 105. When the battery 100 is a sealed battery, the air 105 may be trapped and/or pumped within the vessel and the air electrode 102 may receive oxygen from the air 105. The air electrode 102 may be a gas diffusion layer (GDL) including carbon configured to support oxygen evolution reactions (OERs) and/or oxygen reduction reactions (ORRs) in different modes of operation. The air electrode 102 may be a single air electrode, a “bifunctional electrode,” which operates in both OER and ORR mode, or it may be a combination of two air electrodes, a “dual electrode,” in which one electrode is configured to operate in OER mode and another electrode is configured to operate in ORR mode. In various embodiments, the battery 100 may be configured to operate in a one or modes, such as a discharge mode, a charging (or recharging mode), etc.

The metal electrode 106 may be formed from a metal or metal alloy, such as lithium (Li), sodium (Na), potassium (K), magnesium (Mg), calcium (Ca), silicon (Si), aluminum (Al), zinc (Zn), or iron (Fe); or alloys substantially comprised of one or more of the foregoing metallic elements, such as an aluminum alloy or iron alloy (e.g., FeAl, FeZn, FeMg, etc.). The metal electrode 106 may be a composite metal electrode formed from two or more different materials, such as two or more different metals, a metal and one or more different metal and/or no-metal materials, etc. The metal electrode 106 may be a solid, including a dense or porous solid, or a mesh, felt, or foam, or a particle or collection of particles, or may be a slurry, ink, suspension, gel, or paste deposited within the vessel 101. The metal electrode 106 may be formed from sintered metals, such as sintered iron, sintered porous iron, etc. The metal electrode 106 may be a porous bed of pellets, such as a porous bed of metal pellets (e.g., a bed of direct reduced iron (DRI) pellets, a bed of sponge iron pellets, a bed of atomized iron powder, etc.). In various embodiments, the pellets in the porous bed may be produced from, or may be, iron ore pellets, such as taconite or magnetite or hematite. In various embodiments, the pellets may be produced by reducing iron ore pellets to form a more metallic (more reduced, less highly oxidized) material, such as iron metal (Fe0), wustite (FeO), or a mixture thereof. In various non-limiting embodiments, the pellets may be reduced taconite, direct reduced (“DR”) taconite, “DR Grade” taconite pellets (which are not yet reduced), direct reduced iron (“DRI”) pellets, or any combination thereof. In various embodiments, the metal electrode 106 composition may be selected such that the metal electrode 106 and the volume of liquid electrolyte 104 may not mix together. For example, the metal electrode 106 may be a bulk solid. As another example, the metal electrode 106 may be a collection of particles, such as small or bulky particles, within a suspension that are not buoyant enough to escape the suspension into the electrolyte. As another example, the metal electrode 106 may be formed from particles that are not buoyant in the electrolyte.

The volume of liquid electrolyte 104 may be disposed between the air electrode 102 and the metal electrode 106 such that the air electrode 102 and the metal electrode 106 are electrically isolated while remaining in ionic contact via the volume of liquid electrolyte 104. In this manner the volume of liquid electrolyte 104 may act as an electrolyte layer separating the air electrode 102 and the metal electrode 106. The volume of liquid electrolyte 104 may cover the metal electrode 106 such that the metal electrode 106 is submerged in the volume of liquid electrolyte 104. In this manner the volume of liquid electrolyte 104 may form a barrier between the metal electrode 106 and oxygen in the air 105. The composition of the volume of liquid electrolyte 104 may be selected such that the liquid electrolyte has a low solubility of oxygen, thereby preventing oxygen from the air 105 from reaching the metal electrode 106. The solubility of oxygen in the volume of liquid electrolyte 104 may be tailored to meet different oxygen barrier goals. The metal electrodes 106 exposure to oxygen may be limited to prevent parasitic self-discharging of the metal electrode 106. The volume of liquid electrolyte 104 may serve as a barrier between the metal electrode 106 and gaseous oxygen from the air 105. In various embodiments, the liquid electrolyte 104 may include one or more various electrolyte additives. Electrolyte additives may have a range of solubilities, and some may have the most beneficial effect when the additives are intimately mixed with the metal electrode 106. In certain embodiments, the metal electrode 106 may be pelletized, or comprised of multiple pellet-shaped sub-units. One method of additive delivery may include forming the metal electrode 106 such that the pellets forming the metal electrode 106 include additives. For example, a portion of the pellets forming the metal electrode 106 may be entirely formed of additives. Such additives may include or be sodium sulfide (Na2S) and sodium polysulfides (Na2Sx, where x=1-8), potassium sulfide (K2S), potassium polysulfides (K2Sx, where x=1-8), lithium sulfide (Li2S) and lithium polysulfides (Li2Sx, where x=1-8), iron sulfides (FeSx, where x=1-2), bismuth sulfide (Bi2S3), lead sulfide (PbS), zinc sulfide (ZnS), antimony sulfide (Sb2S3), selenium sulfide (SeS2), tin sulfides (SnS, SnS2, Sn2S3), nickel sulfide (NiS), molybdenum sulfide (MoS2), and mercury sulfide (HgS) . . . . Other pellets forming the metal electrode 106 may be formed mostly of other active material(s). The different types of pellets (e.g., additive pellets and active material pellets) may be mixed to create a blended metal electrode 106. Similarly, when the metal electrode 106 may be a powder or bed of powder, one method of additive delivery may include forming the metal electrode 106 such that the powder or bed of powder forming the metal electrode 106 includes additives.

In some embodiments, a mechanical barrier 195, such as a membrane or porous separator, may be included in the battery 100 and may physically block oxygen bubbles from contacting the metal electrode 106. The mechanical barrier 195 may be a film or sheet of a polymer, such as PBI, PE, PP, PVDF, PTFE, or other polymers, or may be a natural fiber, such as cotton, rayon, or cellulose acetate. The mechanical barrier 195 may be woven, non-woven, or felted. The mechanical barrier 195 may have a porosity such as 50% by volume or greater, or 30% by volume or greater.

Carbon dioxide (CO₂) exposure to, and dissolving in, the volume of liquid electrolyte 104 may cause pH changes in the electrolyte, changes in the electrolyte's ionic conductivity, and the precipitation of carbonate solids in the electrolyte may clog pores in the air electrode 102 and/or metal electrode 106. To address carbon dioxide and/or carbonate ion (CO₃²⁻) build-up in the volume of liquid electrolyte 104, scrubbing or filtration may be used to treat the volume of liquid electrolyte 104 and remove carbon dioxide and/or carbonate. As an example, a filter unit 150 may be used to scrub or filter carbon dioxide and/or carbonate from the volume of liquid electrolyte 104. As one example, the filter unit 150 may include a pump to circulate electrolyte through a filter to remove carbon dioxide and/or carbonate out of the volume of liquid electrolyte 104. The carbon dioxide may be vented to the air 105. Alternatively, the carbon dioxide and/or carbonate may be trapped in the filter unit 150 and the filter unit 150 may be replaced periodically. For example, the filter unit 150 may contain a chemical reagent or scrubber, that reacts strongly with carbon dioxide and/or carbonate to bind and trap the unwanted species. For example, a gas-phase filter may use sodium hydroxide (NaOH), lithium hydroxide (LiOH), potassium hydroxide (KOH), calcium hydroxide (Ca(OH)₂), magnesium hydroxide (Mg(OH)₂), barium hydroxide (Ba(OH)₂) or a mixture of these reagents to trap carbon dioxide chemically before it reaches the cell.

Alternatively, the filter unit 150 may flow through electrolyte which has dissolved carbon dioxide and/or carbonate and expose this electrolyte to a reactive medium that binds and/or reacts with carbonate ions to remove them from the solution. For example, if the electrolyte is primarily potassium hydroxide, the filter may contain solid calcium hydroxide. The solubility of calcium carbonate is much lower than the solubility of potassium carbonate, so the dissolved carbonate will react with the calcium hydroxide to form calcium carbonate which will precipitate from the electrolyte and accumulate in the filter unit. The filter unit 150 may be periodically replaced or refreshed or refurbished to restore it. The filter unit 150 may run at various intervals, such as intervals matched to the carbon dioxide diffusion rate into the cell, to filter out carbon dioxide and/or carbonate from the volume of liquid electrolyte 104. This may maintain the volume of liquid electrolyte 104 with a sufficiently low carbon dioxide and/or carbonate levels to prevent or mitigate the pH changes in the electrolyte, changes in the electrolytes ionic conductivity, and/or the precipitation of carbonate solids in the electrolyte. As an example, the filter unit 150 may be a scrubbing reactor where air may be pumped through an electrolyte bath in the filter unit 150 including one or more concentrated alkali hydroxide salts (e.g., NaOH). The reactor that may be the filter unit 150 in such an example may be configured such that the total pressure drop through the reactor is low, but the gas residence time may be increased by creating long winding channels with a positive vertical slope in the reactor. The filter unit 150 may include channels, baffles, ridges, ribs, or other physical features to improve convective mixing in the reactor. The convective mixing may permit a small energy loss while maximizing carbon dioxide removal from the air.

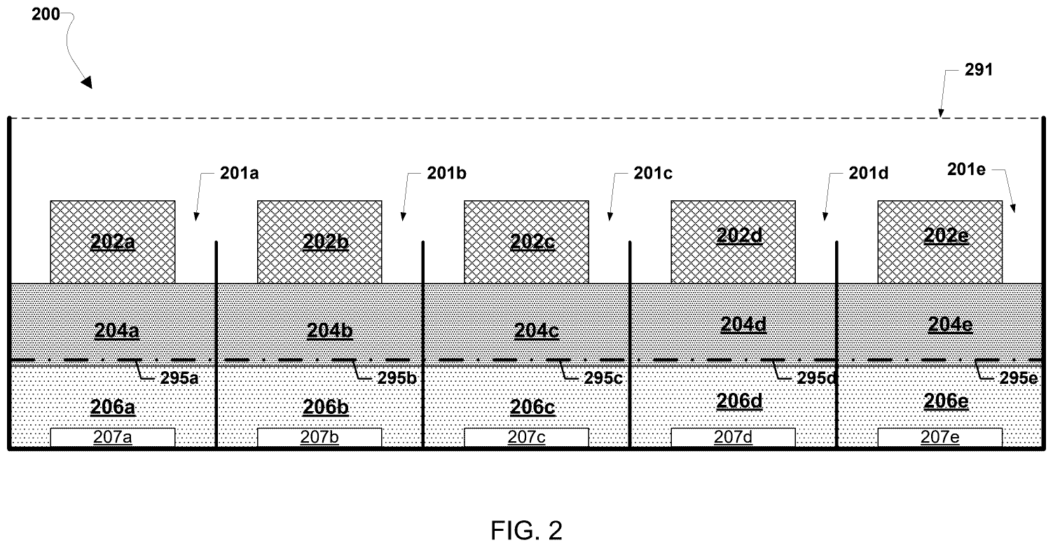

FIG. 2 is a block diagram of an embodiment multi-vessel battery 200. In some embodiments, the multi-vessel battery 200 may be an unsealed battery open to the environment, such that air 105 passes freely into and out of the battery 200. In some optional embodiments, the multi-vessel battery 200 may be a sealed battery having a lid 291 (or other type containment structure) sealing off the multi-vessel battery 200 from the environment. In such a sealed configuration, volumes of air 105 may be pumped into the multi-vessel battery 200 and/or be trapped in the multi-vessel battery 200 itself by the lid 291 (or other type containment structure). The multi-vessel battery 200 may be similar to battery 100 described above, except, rather than one vessel 101, the battery 200 may include a series of separate vessels, such as five separate vessels 201a, 201b, 201c, 201d, 201e. While illustrated as having five separate vessels, a multi-vessel battery may have more than five vessels, less than five vessels, etc. Additionally, while illustrated in FIG. 2 as a single row of vessels, 201a, 201b, 201c, 201d, 201e, the vessels of a multi-vessel battery may be arranged in linear arrangements of one or more rows and one or more columns of vessels. Vessel size and arrangements may be tailored to reach current and voltage targets for the multi-vessel battery. Additionally, while illustrated in FIG. 2 as having one common lid 291 in a sealed configuration, alternatively each vessel 201a, 201b, 201c, 201d, 201e may have its own respective lid. In various embodiments, the battery 200 may be configured to operate in a one or modes, such as a discharge mode, a charging (or recharging mode), etc.

Each vessel 201a, 201b, 201c, 201d, 201e may have its own respective air electrode 202a, 202b, 202c, 202d, 202e, its own respective volume of liquid electrolyte 204a, 204b, 204c, 204d, 204e, and its own respective metal electrode 206a, 206b, 206c, 206d, 206e. The air electrodes 202a, 202b, 202c, 202d, 202e may be similar to the air electrode 102 described above, the volumes of liquid electrolyte 204a, 204b, 204c, 204d, 204e may be similar to the volume of liquid electrolyte 104 described above, and the metal electrodes 206a, 206b, 206c, 206d, 206e may be similar to the metal electrode 106 described above. Each volume of liquid electrolyte 204a, 204b, 204c, 204d, 204e may act as a barrier protecting its respective associated metal electrode 206a, 206b, 206c, 206d, 206e that is submerged in it from oxygen in the air environment. Optionally, each vessel 201a, 201b, 201c, 201d, 201e may have its own respective mechanical barrier 295a, 295b, 295c, 295d, 295e configured to physically block oxygen bubbles from contacting the respective metal electrode 206a, 206b, 206c, 206d, 206e. The mechanical barriers 295a, 295b, 295c, 295d, 295e may be similar to the mechanical barrier 195 described above. Each vessel 201a, 201b, 201c, 201d, 201e may have its own current collector 207a, 2076, 207c, 207d, 207e in contact with the metal electrodes 206a, 206b, 206c, 206d, 206e. The connections between each of the metal electrodes 206a, 206b, 206c, 206d, 206e and each of the air electrodes 202a, 202b, 202c, 202d, 202e may be in series and/or in parallel and may be arranged to reach current and/or voltage targets for the battery 200. For example, linking in series may step up voltage and linking in parallel may step up current.

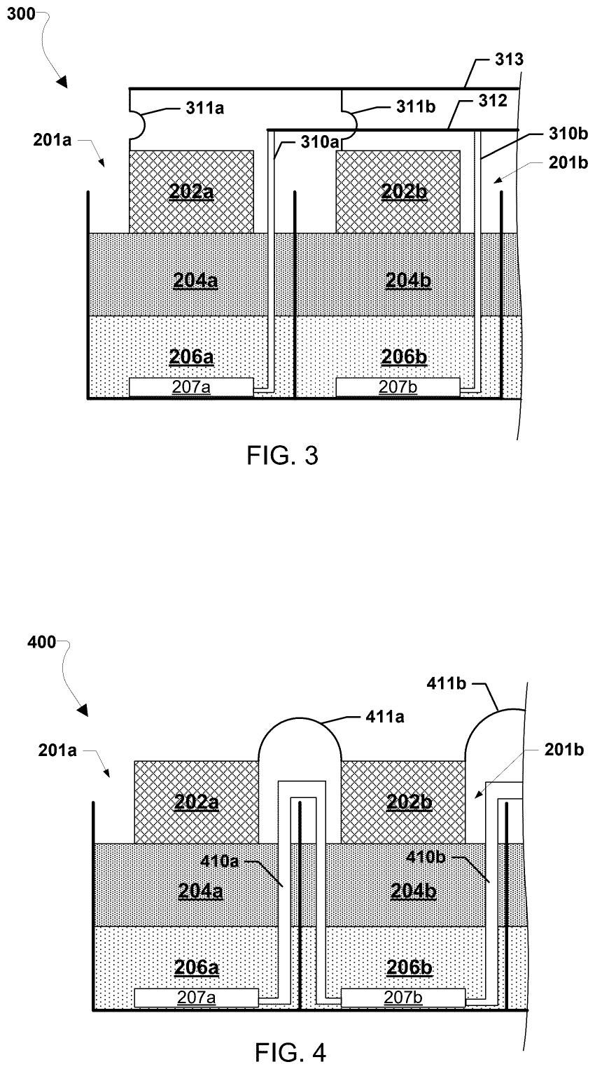

FIG. 3 is a block diagram of a portion 300 of multi-vessel battery 200 showing vessels 201a and 201b with parallel connections. The current collectors 207a and 207b may be connected by insulated leads 310a and 310b, respectively, to a common lead 312 for all current collectors. In some embodiments, the current collectors 207a and 207b may be two part collectors with a first part attached to a front face of the metal electrodes 206a and 206b and a second part attached to a back face of the metal electrodes 260a and 206b. The front face of an electrode may be the surface disposed generally toward the electrolyte and the back face of an electrode may be the surface disposed generally away from the electrolyte. In some embodiments, the first part may be attached to the front face may be a porous structure (e.g., a mesh) and the second part attached to the back face may be a solid. Having the current collector on the front face of the electrode and back face of the electrode may aid in applying a clamp force and may enable more uniform reaction rates throughout the entire electrode. The front and back portions of the current collectors may be short circuited together to impact reaction rate distributions. While illustrated and discussed in relation to FIG. 3 as related to the metal electrodes of a battery, current collectors arranged on the front and back face of the electrode may also be used with air electrodes, such as air electrodes 202a, 202b, etc. In some embodiments, the current collectors 207a, 207b may clamp onto the metal electrodes 206a, 206b. The insulated leads 310a and 310b may be insulated from the electrolyte and metal electrodes. In some embodiments, the insulated leads 310a and 310b may be rigid posts extending through the electrolyte and metal electrodes to the current collectors 207a, 207b. The air electrodes 202a and 202b may be connected by leads 311a and 311b, respectively, to a common lead 313 for all air electrodes. The open design of the battery 200 may not require current feedthrough passages in the vessels and the insulated leads 310a and 310b may exit the electrolyte at any point. In a sealed design, feedthrough passages may be provided, such as in the lid 295.

FIG. 4 is a block diagram of a portion 400 of multi-vessel battery 200 showing vessels 201a and 201b with series connections. The current collectors 207a and 207b may be connected to each other by insulated lead 410a. In an open configuration, insulated lead 410a may exit the volume of liquid electrolyte 204a and pass over the edge of vessel 201a into vessel 201b and into the volume of liquid electrolyte 204b to connect to current collector 207b. In a similar manner insulated lead 410b may connect current collector 207b to current collector 207c. The insulated leads 410a and 410b may be insulated from the electrolyte and metal electrodes. The air electrodes 202a and 202b may be connected by lead 411a. In a similar manner lead 411b may connect air electrode 202b to air electrode 202c. In a configuration where one or more lid may be provided, feedthroughs may be provided to pass the leads, such as leads 410a, 410b, 411a, 411b, etc.

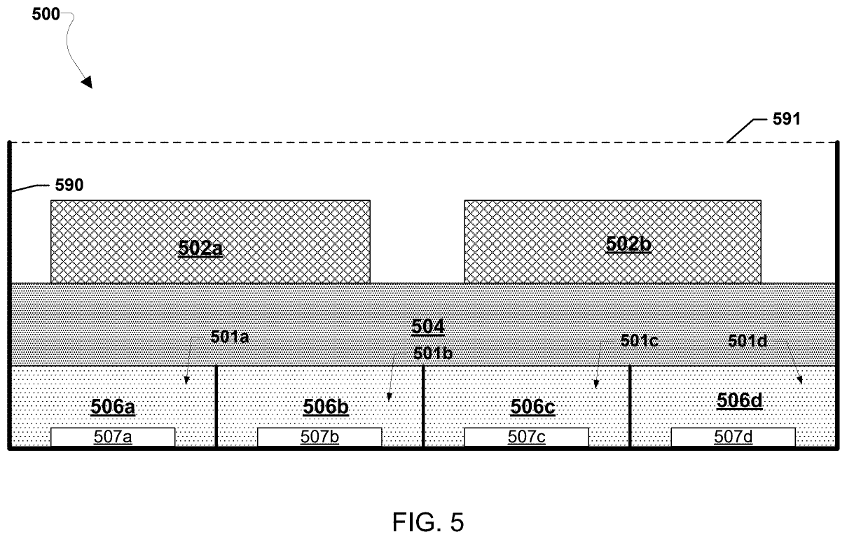

FIG. 5 is a block diagram of another embodiment multi-vessel battery 500. In some embodiments, the multi-vessel battery 500 may be an unsealed battery open to the environment, such that air passes freely into and out of the battery 500. In some optional embodiments, the multi-vessel battery 500 may be a sealed battery having a lid 591 (or other type containment structure) sealing off the multi-vessel battery 500 from the environment. In such a sealed configuration, volumes of air may be pumped into the multi-vessel battery 500 and/or be trapped in the multi-vessel battery 500 itself by the lid 591 (or other type containment structure). The multi-vessel battery 500 is similar to battery 100 described above, except rather than one vessel 101, the battery 500 may include a series of separate vessels, such as four separate vessels 501a, 501b, 501c, 501d. The four separate vessels 501a, 501b, 501c, 501d may be formed within a larger common vessel 590. While illustrated as having four separate vessels, a multi-vessel battery may have more than four vessels, less than four vessels, etc. Additionally, while illustrated in FIG. 5 as a single row of vessels, 501a, 501b, 501c, 501d within a larger common vessel 590, the vessels of a multi-vessel battery may be arranged in linear arrangements of one or more rows and one or more columns of vessels. Vessel size and arrangements may be tailored to reach current and voltage targets for the multi-vessel battery. In various embodiments, the battery 500 may be configured to operate in a one or modes, such as a discharge mode, a charging (or recharging mode), etc.

Each vessel 501a, 501b, 501c, 501d may have its own respective metal electrode 506a, 506b, 506c, 506d. The metal electrodes 506a, 506b, 506c, 506d may be similar to the metal electrodes 106 described above. Each vessel 501a, 501b, 501c, 501d may have its own respective current collector 507a, 507b, 507c, 507d in contact with the metal electrodes 506a, 506b, 506c, 506d.

A single volume of liquid electrolyte 504 may submerge each metal electrode 506a, 506b, 506c, 506d and may pass between all the vessels 501a, 501b, 501c, 501d within the larger common vessel 590. In this manner, the metal electrodes 506a, 506b, 506c, 506d may all be associated with a common single electrolyte layer and may thereby effectively share the same electrolyte layer. The volume of liquid electrolyte 504 may be similar to the volume of liquid electrolyte 104 described above. The volume of liquid electrolyte 504 may act as a barrier protecting all the metal electrodes 506a, 506b, 506c, 506d submerged in it in their respective vessels 501a, 501b, 501c, 501d from oxygen in the air environment.

Optionally, each vessel 501a, 501b, 501c, 501d and/or the overall vessel 590 may have one more respective mechanical barriers configured to physically block oxygen bubbles from contacting the metal electrodes 506a, 506b, 506c, 506d. The mechanical barriers may be similar to the mechanical barrier 195 described above.

The air electrodes 502a and 502b may be separated from the metal electrodes 506a, 506b, 506c, 506d by the volume of liquid electrolyte 502. The air electrodes 502a and 502b may be similar to the air electrode 102 described above. The air electrode 502a may be in ionic contact with metal electrodes 506a and 506b and the air electrode 502b may be in ionic contact with metal electrodes 506c and 506d. The presence of a common volume of liquid electrolyte 504 and the air electrodes 502a, 502b in the larger common vessel 590 rather than in each separate vessel 501a, 501b, 501c, 501d may enable separate sizing of the air electrodes 502a, 502b from the metal electrodes 506a, 506b, 506c, 506d, in the battery 500. While illustrated as having two air electrodes, the battery may include less than two or more than two air electrodes in various embodiments.

The connections between each of the metal electrodes 506a, 506b, 506c, 506d and each of the air electrodes 502a, 502b may be in series and/or in parallel and may be arranged to reach current and/or voltage targets for the battery 500. For example, linking in series may step up voltage and linking in parallel may step up current.

A charged metal electrode in an electrolyte may self-discharge. For example, a reduced iron (Fe) electrode in an alkaline solution will self-discharge according to the spontaneous reaction Fe+2H₂O═Fe(OH)₂+H₂. In an open metal-air battery (i.e., an unsealed battery), such as an iron-air (Fe-air) battery, it is possible to provide for removing a metal electrode from the electrolyte to prevent self-discharge of the metal electrode. In various embodiments, a pump may pump liquid electrolyte into and out of a vessel of a battery such that the metal electrode is submerged in the liquid electrolyte when the liquid electrolyte is pumped into the vessel and the metal electrode is removed from the liquid electrolyte when the liquid electrolyte is pumped out of the vessel. In various embodiments, a gas filled bladder may be inflated and deflated to displace the liquid electrolyte such that the metal electrode is submerged in the liquid electrolyte when the gas bladder is inflated and the metal electrode is removed from the liquid electrolyte when the gas bladder is deflated. In various embodiments, one or more lifting systems may raise and lower the metal electrode out of and into the liquid electrolyte. Removing the metal electrode from the electrolyte may prevent self-discharge of the metal electrode.

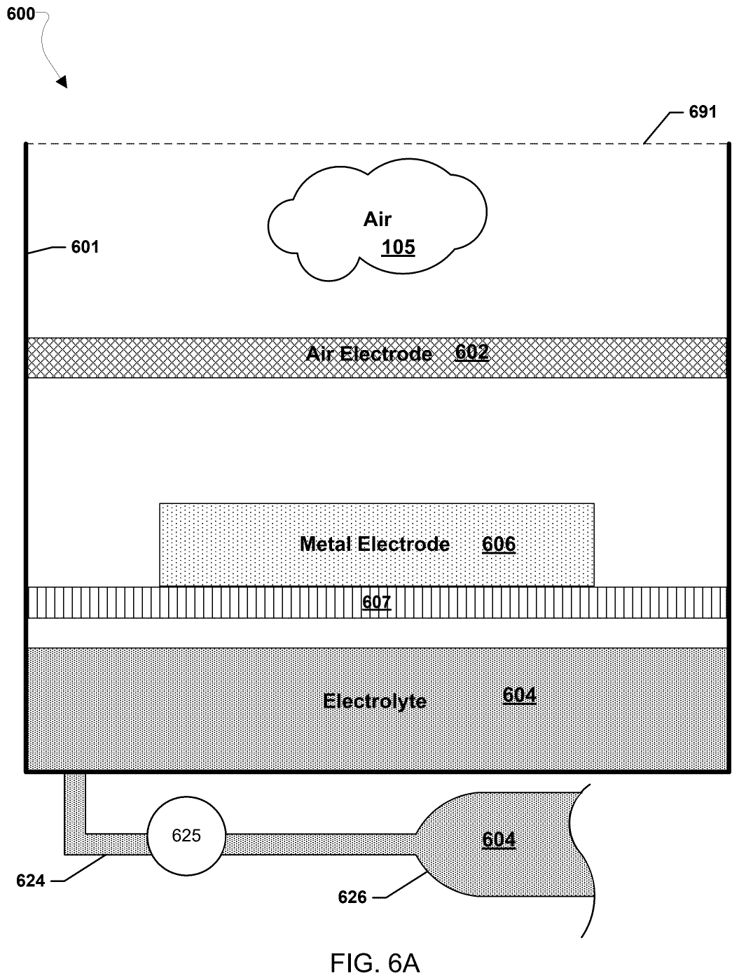

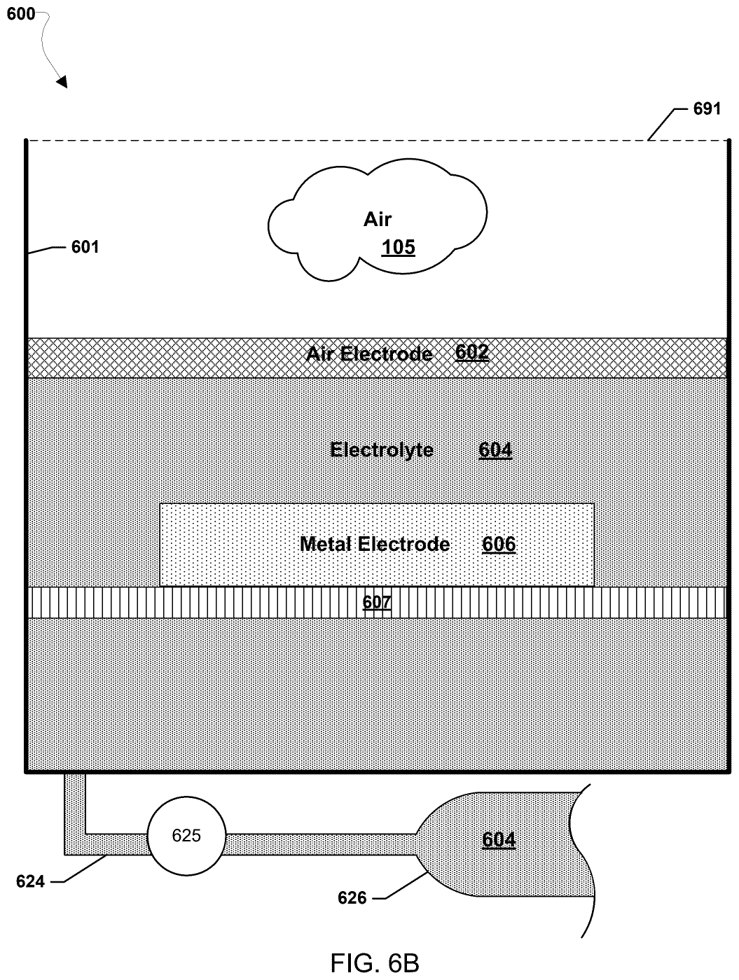

FIGS. 6A and 6B show a battery 600 according to an embodiment in an operating state with the metal electrode 606 removed from a volume of liquid electrolyte 604 (FIG. 6A) and in an operating state with the metal electrode 606 submerged in the volume of liquid electrolyte 604 (FIG. 6B). The battery 600 may be similar to battery 100 described above except that the metal electrode 606 may be supported on a rigid porous current collector 607 within the vessel 601. In some embodiments, the battery 600 may be an unsealed battery open to the environment, such that air 105 passes freely into and out of the battery 600. In some optional embodiments, the battery 600 may be a sealed battery having a lid 691 (or other type containment structure) sealing off the battery 600 from the environment. In such a sealed configuration, volumes of air 105 may be pumped into the battery 600 and/or be trapped in the battery 600 itself by the lid 691 (or other type containment structure). Air electrode 602 may be similar to air electrode 102 described above, metal electrode 606 may be similar to metal electrode 106 described above, and the volume of liquid electrolyte 604 may be similar to the volume of liquid electrolyte 104 described above. In various embodiments, the battery 600 may be configured to operate in a one or modes, such as a discharge mode, a charging (or recharging mode), etc.

An electrolyte passage 624 may fluidically couple an electrolyte reservoir 626 to the vessel 601. A pump 625 may be fluidically coupled to the electrolyte passage 624 and thereby fluidically coupled to the vessel 601. The pump 625 may operate to pump electrolyte from the electrolyte reservoir 626 into the vessel 601 to raise the level of the volume of liquid electrolyte 604 and may pump electrolyte out of the vessel 601 into the electrolyte reservoir 626 to lower the level of the volume of liquid electrolyte 604. FIG. 6A shows the battery 600 in an operating state in which the electrolyte is pumped out of the vessel 601 to reduce the volume of liquid electrolyte 604 to a level such that the metal electrode 606 is removed from the electrolyte. In this manner, self-discharge may be prevented by removing the electrolyte from the metal electrode 606. The mode of operation shown in FIG. 6A corresponds to an energy storing mode of operation. FIG. 6B shows the battery 600 in another operating state in which the electrolyte is pumped into the vessel 601 to increase the volume of liquid electrolyte 604 to a level such that the metal electrode 606 is submerged in the electrolyte. The mode of operation shown in FIG. 6B corresponds to an active charging or discharging mode of operation. Draining the electrolyte from the metal electrode 606 may prevent self-discharge of the metal electrode 606.

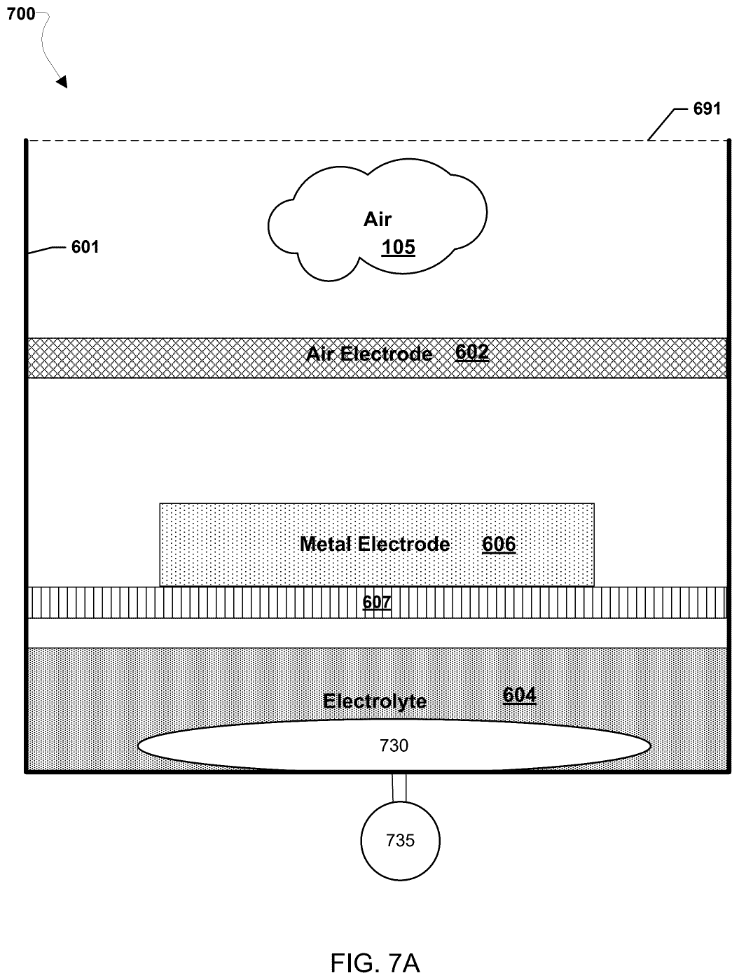

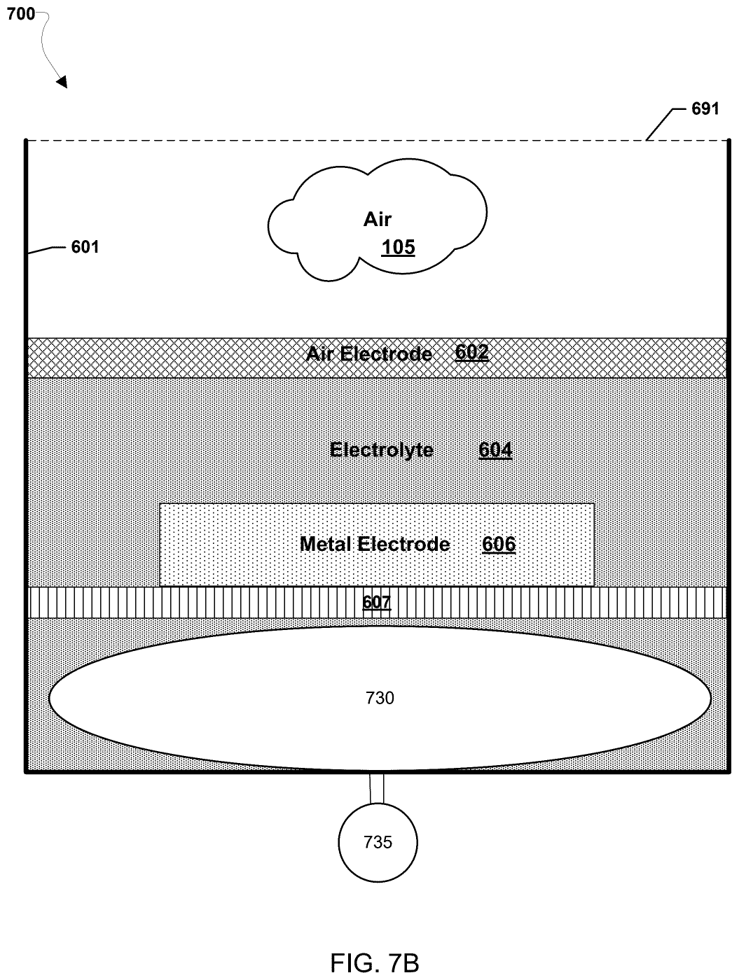

FIGS. 7A and 7B show a battery 700 according to an embodiment in an operating state with the metal electrode 606 removed from a volume of liquid electrolyte 604 (FIG. 7A) and in an operating state with the metal electrode 606 submerged in the volume of liquid electrolyte 604 (FIG. 7B). The battery 700 may be similar to battery 600 described above except that rather than a pump 625 pumping electrolyte into and out of the vessel 601, a gas filled bladder 730 may change the electrolyte level. The gas filled bladder 730 may be disposed within the volume of liquid electrolyte 604. The gas filled bladder 730 may be formed from elastic material and may expand and contract, as gas, such as air, is pumped into and out of the gas filled bladder 730 by a pump 735. The pump 735 may operate to pump gas, such as air, into the gas filled bladder 730 to expand the gas filled bladder 730 in the vessel 601. As the gas filled bladder 730 expands it may displace more electrolyte thereby raising the level of the volume of liquid electrolyte in the vessel 601 to submerge the metal electrode 606 in electrolyte as shown in FIG. 7B. The pump 735 may operate pump gas, such as air, out of the gas filled bladder 730 to contract the gas filled bladder 730 in the vessel 601. As the gas filled bladder 730 contracts it may displace less electrolyte thereby dropping the level of the volume of liquid electrolyte in the vessel 601 to expose the metal electrode 606 to air 105 and remove the metal electrode 606 from the electrolyte as shown in FIG. 7A. Removing the electrolyte from the metal electrode 606 may prevent self-discharge of the metal electrode 606.

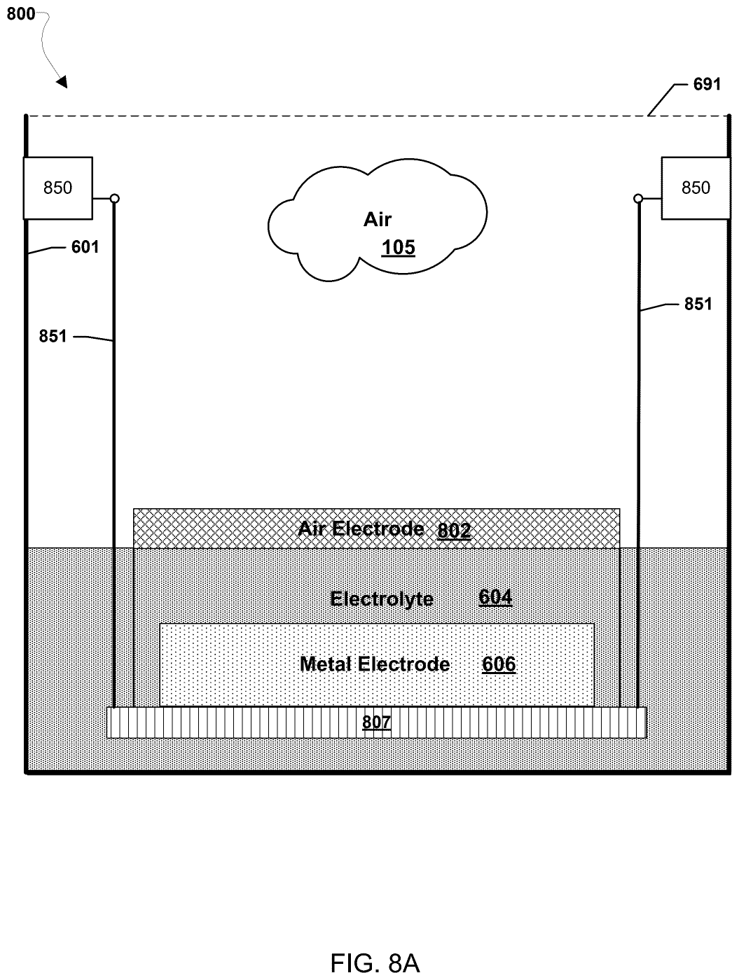

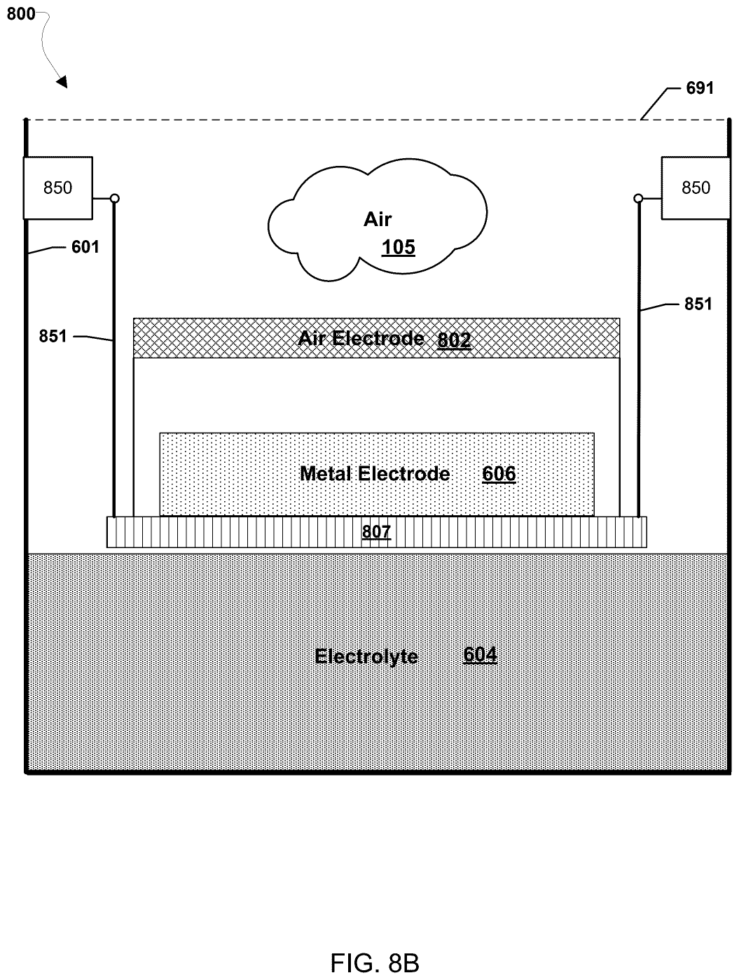

FIGS. 8A and 8B show a battery 800 according to an embodiment in an operating state with the metal electrode 606 removed from a volume of liquid electrolyte 604 (FIG. 8B) and in an operating state with the metal electrode 606 submerged in the volume of liquid electrolyte 604 (FIG. 8A). The battery 800 may be similar to battery 600 described above except that rather than a pump 625 pumping electrolyte into and out of the vessel 601, a lifting system may raise and lower the metal electrode 606 into and out of the volume of liquid electrolyte 604. The lifting system may include one or more motors 850 coupled to the vessel 601. One or more drive elements 851, such as belts, chains, screws, gears, etc., may be coupled to the one or more motors 850 and coupled to the rigid porous current collector 807, thereby coupling the lifting system to the rigid porous current collector 807. The metal electrode 606 may be supported by the rigid porous current collector 807. Additionally, the air electrode 802 may be supported by the rigid porous current collector 807. The lifting system may lower the rigid porous current collector 807 and metal electrode into the volume of liquid electrolyte 604 to submerge the metal electrode 606 in electrolyte as shown in FIG. 8A. The lifting system may raise the rigid porous current collector 807 and metal electrode out of the volume of liquid electrolyte 604 to expose the metal electrode 606 to air 105 and remove the metal electrode 606 from the electrolyte as shown in FIG. 8B. Removing the metal electrode 606 from the electrolyte may prevent self-discharge of the metal electrode 606.

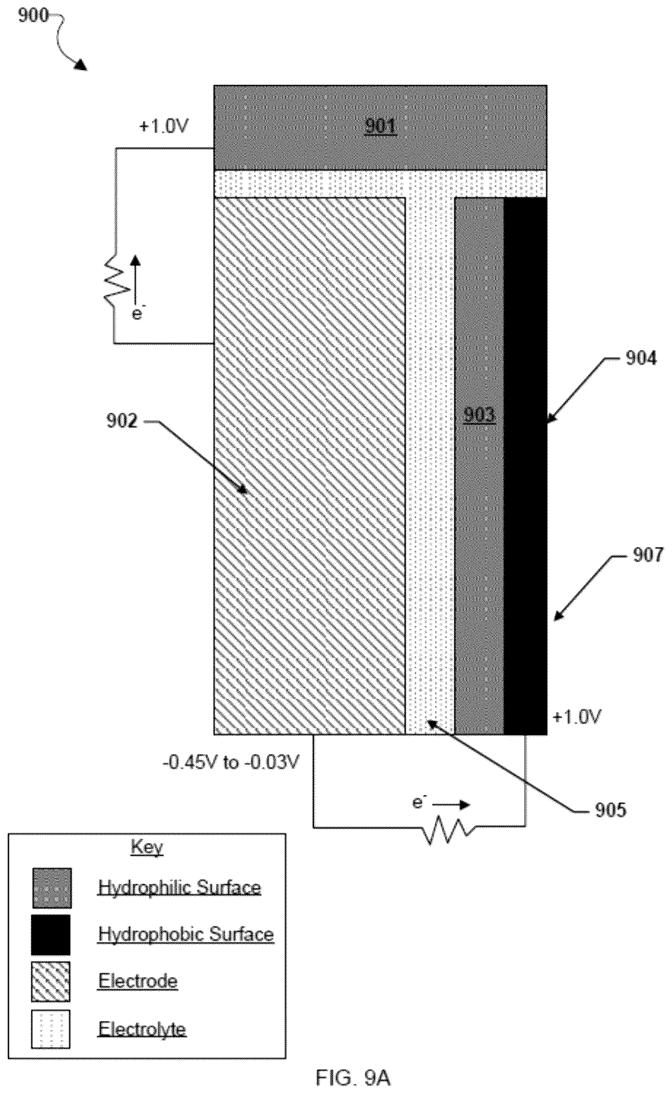

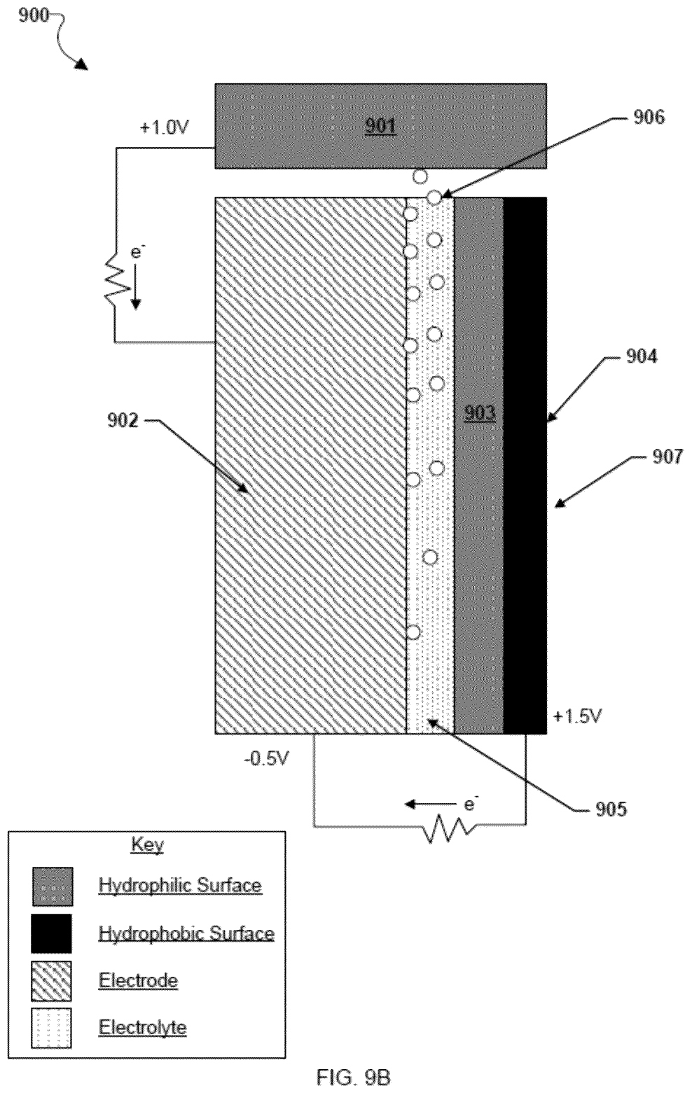

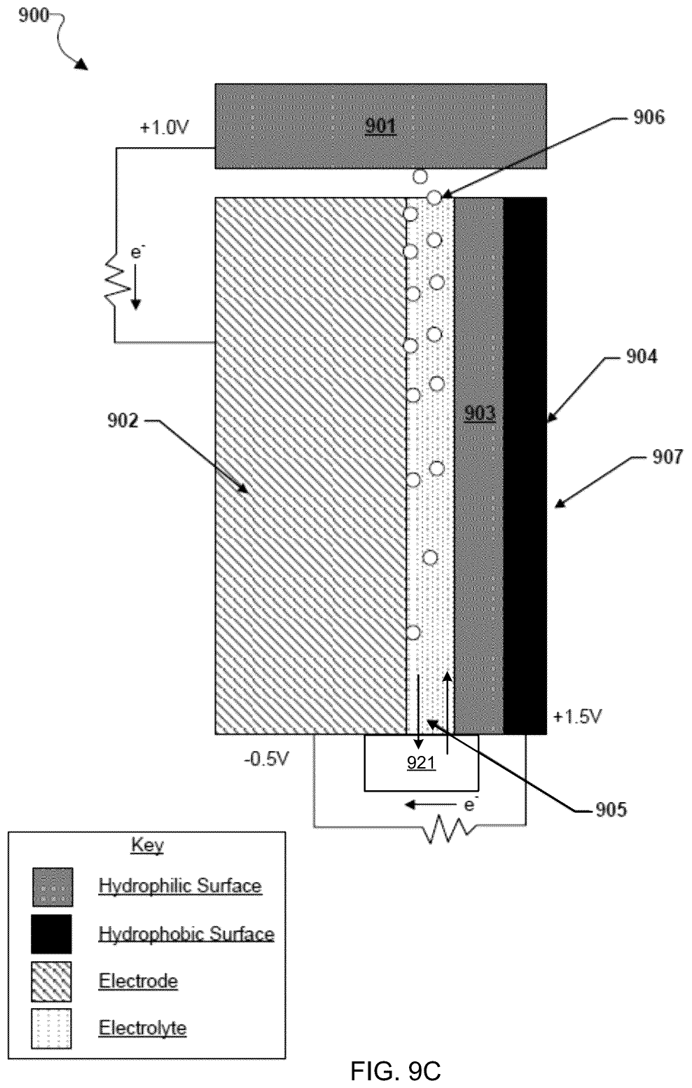

FIGS. 9A and 9B are block diagrams of an embodiment three electrode battery 900 operating in a discharge mode (FIG. 9A) and a recharge mode (FIG. 9B), respectively.

In various embodiments, battery 900 may include three electrodes, an anode 902, a first cathode 907, and a second cathode 901. The electrodes may have finite useful lifetimes, and may be mechanically replaceable. For example, anode 902 may be replaced annually, seasonally, monthly, weekly, or on some other specified period of replacement. The first cathode 907 may be divided into two portions, a first portion 903 having a hydrophilic surface and a second portion 904 having a hydrophobic surface. For example, the hydrophobic surface may have a polytetrafluorethylene (PTFE) (e.g., Teflon®) hydrophobic surface. For example, the second portion 904 may be a microporous layer (MPL) of polytetrafluorethylene (PTFE) and high surface area carbon while the first portion 903 may be carbon fiber partially coated with PTFE. As another example, the second portion 904 may be a MPL of PTFE and carbon black and the first portion 903 may be PTFE of approximately 33% by weight. As a further example, the second portion 904 may be an MPL of 23% by weight PTFE and 77% by weight carbon black and the first portion 903 may be a low loading MPL. The anode 902 may be an iron (Fe) electrode or an iron-alloy (Fe-alloy) electrode (e.g., FeAl, FeZn, FeMg, etc.). The second cathode 901 may have a hydrophilic surface. The second cathode 901 may have a metal substrate, such as carbon (C), titanium (Ti), steel, copper, etc., coated with nickel (Ni). Electrolyte 905 may be disposed between the three electrodes 901, 902, and 903. The electrolyte 905 may be infiltrated into one or more of the three electrodes 901, 902, and 903.

In a discharge mode of operation illustrated in FIG. 9A, electrolyte 905 may flood the surfaces of the anode 902, first cathode 907, and second cathode 901. In the discharge mode of operation, the battery 900 may generate power. The first and second cathodes may be at the same higher potential than the anode in this mode (e.g., the cathodes may be at a positive potential and the anode may be at a negative potential). For example, when the anode 902 is a Fe anode, the anode 902 may have a potential of −0.45 to −0.03V vs. regular hydrogen electrode (RHE) in the discharge mode and the first cathode 907 and second cathode 901 may have the same potentials of +1.0V vs. RHE. In the discharge mode, a two phase oxygen reduction reaction (ORR) may occur at the first cathode 907 and a flooded oxygen reduction reaction (ORR) may occur at the second cathode 901.

In a recharge mode of operation illustrated in FIG. 9B, the level of electrolyte 905 may be reduced to expose the second cathode 901 to air. The level of the electrolyte 905 in the battery 900 may be controlled by pumps, valves, and/or other systems to transition the level of the electrolyte 905 to flood or not flood the second cathode 901 in the discharge and recharge modes, respectively. In the recharge mode, a dry hydrogen oxidation reaction (HOR) may occur at the second cathode 901 and a two phase oxygen evolution reaction (OER) may occur at the first cathode 907. When the anode 902 is an Fe anode, hydrogen (H₂) bubbles 906 may be created by the anode 902 in the recharge mode in a parasitic process. The hydrogen (H₂) bubbles 906 may be oxidized (i.e., electrons recaptured) at the second cathode 901. The two cathodes 901 and 907 may have different positive potentials with regard to the anode 902 in the recharge mode, such as 0.1V and 1.5V (vs. RHE), respectively, while the anode may be at −0.5V vs. RHE. This may keep the second cathode 901 at a more favorable 0.1V potential vs. RHE as it oxidizes hydrogen (H₂) bubbles 906 produced by the anode 902. Additionally, the separation of the anode 902 from other components of the battery 900, such as cathode 907, may protect those separate components from bubble damage caused by the bubbles from the anode 902. For example, as the placement of such bubble sensitive parts away from (and/or below) the anode 902 may ensure that the sensitive parts are not in the bubble path because the bubbles will flow upward in the liquid electrolyte 905.

In some instances, hydrogen (H₂) bubbles generated at the anode 902 can become mechanically pinned or stuck at unwanted sites in the battery 900, and cause increases in cell impedance. This may be mitigated by agitating the bubbles by circulating the electrolyte 905, through natural or forced convection. In certain embodiments, the recirculation occurs naturally (natural convection) inside of the battery 900 due to the movement of oxygen bubbles that are generated at the positive electrode during the charging process in the cell. In certain other embodiments, the circulation occurs due to forced pumping of liquid electrolyte 905. For example, such an embodiment is illustrated in FIG. 9C in which an electrolyte circulation pump 921 is used to pump electrolyte 905 into and/or out of the battery 900. In certain embodiments, the flow of electrolyte 905 may be a fully closed loop and there may be no change to the composition of the electrolyte 905 through the flow loop. In certain other embodiments, the recirculation loop may further include mechanisms for adjusting the composition of the electrolyte 905. For example, in certain embodiments, additional water (H₂O) may be added to the electrolyte 905 during pumping to compensate for water lost to hydrogen generation. In certain other embodiments, the pH of the electrolyte 905 may be titrated by the addition of NaOH or other base or acid to the electrolyte 905 during pumping.

In certain other embodiments, carbonate ions

$${(}_{3}^{2 -} {CO}_{3}^{2 -} )$$

may be scrubbed from the electrolyte 905 during pumping by ion-exchange of Ca(OH)₂ to CaCO₃. In certain other embodiments, other electrolyte components, such as sodium sulfide (Na₂S) or lithium hydroxide (LiOH) may be added to the electrolyte 905 during pumping.

Two problems that may arise with a stagnant electrolyte 905 are the formation of bubbles and the creation of a pH gradient during both charge and discharge. Bubbles may not escape from the electrolyte 905 and may become stuck on the electrodes, leading to a performance decay. A pH gradient in the electrolyte 905 can also lead to performance decay or corrosion of the electrodes. One solution to both the issue of bubbles and a pH gradient may be to circulate electrolyte 905 at a low flow rate, such as less than 1 mL/min/cm², for example using the electrolyte circulation pump 921. This flow of electrolyte 905 may provide convenient or even automatic bubble management by making it easier for bubbles to escape. Additionally, flowing electrolyte 905 may provide pH control so that a gradient does not form.

Alkaline iron electrode batteries operate best with certain additives in the electrolyte and/or cell in general. For example, sulfur aids in de-passivation of iron electrodes, but sulfur species may be consumed or degraded during the operation and/or storage of the battery. Sulfur consumption contributes to a fade in capacity over many cycles. A delivery system therefore may be provided to replenish sulfur supplies in order to maintain battery performance.

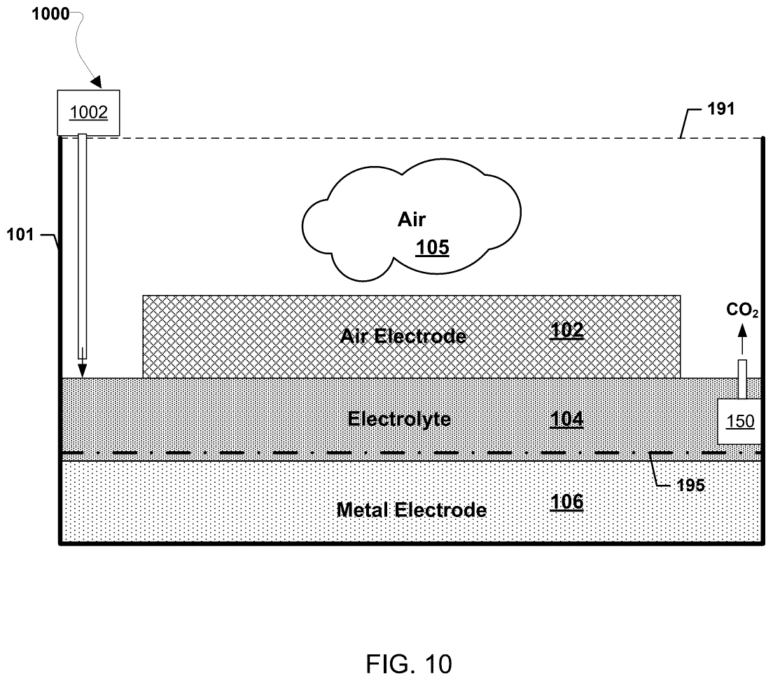

FIG. 10 is a block diagram of an embodiment battery 1000 including a sulfur delivery system 1002. In some embodiments, the battery 1000 may be an unsealed battery open to the environment, such that air 105 passes freely into and out of the battery 1000. In some optional embodiments, the multi-vessel battery 1000 may be a sealed battery having a lid 191 (or other type containment structure) sealing off the battery 1000 from the environment. In such a sealed configuration, volumes of air 105 may be pumped into the battery 1000 and/or be trapped in the multi-vessel battery 1000 itself by the lid 191 (or other type containment structure). The 1000 may be similar to battery 100 described above, except, the battery 1000 may include the sulfur delivery system 1002. In one embodiment, the sulfur delivery system 1002 may be a pump that delivers sulfur-bearing liquid to the battery 1000. In another embodiment, the sulfur delivery system 1002 may be a dry hopper that delivers polysulfide salts to the battery 1000. Examples of polysulfide salts include sodium sulfide (Na₂S) and sodium polysulfides (Na₂Sₓ, where x=1-8), potassium sulfide (K₂S), potassium polysulfides (K₂Sₓ, where x=1-8), lithium sulfide (Li₂S) and lithium polysulfides (Li₂Sₓ, where x=1-8), iron sulfides (FeSₓ, where x=1-2), bismuth sulfide (Bi₂S₃), lead sulfide (PbS), zinc sulfide (ZnS), antimony sulfide (Sb₂S₃), selenium sulfide (SeS₂), tin sulfides (SnS, SnS₂, Sn₂S₃), nickel sulfide (NiS), molybdenum sulfide (MoS₂), and mercury sulfide (HgS).

Various embodiments may provide devices and/or methods for use in bulk energy storage systems, such as long duration energy storage (LODES) systems, short duration energy storage (SDES) systems, etc. As an example, various embodiments may provide batteries (e.g., batteries 100, 200, 500, 600, 700, 800, 900, 1000, etc.) for bulk energy storage systems, such as batteries for LODES systems. Renewable power sources are becoming more prevalent and cost effective. However, many renewable power sources face an intermittency problem that is hindering renewable power source adoption. The impact of the intermittent tendencies of renewable power sources may be mitigated by pairing renewable power sources with bulk energy storage systems, such as LODES systems, SDES systems, etc. To support the adoption of combined power generation, transmission, and storage systems (e.g., a power plant having a renewable power generation source paired with a bulk energy storage system and transmission facilities at any of the power plant and/or the bulk energy storage system) devices and methods to support the design and operation of such combined power generation, transmission, and storage systems, such as the various embodiment devices and methods described herein, are needed.

A combined power generation, transmission, and storage system may be a power plant including one or more power generation sources (e.g., one or more renewable power generation sources, one or more non-renewable power generations sources, combinations of renewable and non-renewable power generation sources, etc.), one or more transmission facilities, and one or more bulk energy storage systems. Transmission facilities at any of the power plant and/or the bulk energy storage systems may be co-optimized with the power generation and storage system or may impose constraints on the power generation and storage system design and operation. The combined power generation, transmission, and storage systems may be configured to meet various output goals, under various design and operating constraints.

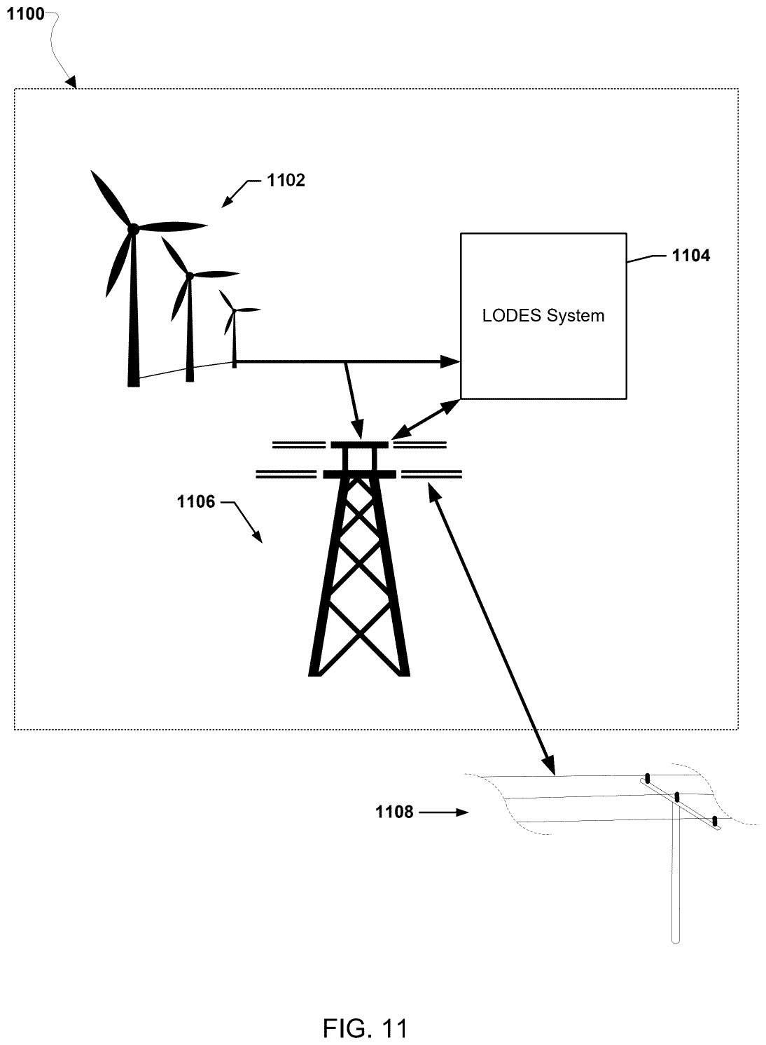

FIGS. 11-19 illustrate various example systems in which one or more aspects of the various embodiments may be used as part of bulk energy storage systems, such as LODES systems, SDES systems, etc. For example, various embodiment batteries described herein (e.g., batteries 100, 200, 500, 600, 700, 800, 900, 1000, etc.) may be used as batteries for bulk energy storage systems, such as LODES systems, SDES systems, etc. and/or various one or more battery components, singularly or in various combinations, such as electrodes, leads, pumps, mechanical barriers, current collectors, bladders, lifting systems, etc., as described herein may be used as components for bulk energy storage systems. As used herein, the term “LODES system” may mean a bulk energy storage system configured to may have a rated duration (energy/power ratio) of 24 hours (h) or greater, such as a duration of 24 h, a duration of 24 h to 50 h, a duration of greater than 50 h, a duration of 24 h to 150 h, a duration of greater than 150 h, a duration of 24 h to 200 h, a duration greater than 200 h, a duration of 24 h to 500 h, a duration greater than 500 h, etc.

FIG. 11 illustrates an example system in which one or more aspects of the various embodiments may be used as part of bulk energy storage system. As a specific example, the bulk energy storage system incorporating one or more aspects of the various embodiments may be a LODES system 1104. As an example, the LODES system 1104 may include various embodiment batteries described herein (e.g., batteries 100, 200, 500, 600, 700, 800, 900, 1000, etc.) and/or various one or more battery components, singularly or in various combinations, such as electrodes, leads, pumps, mechanical barriers, current collectors, bladders, lifting systems, etc., as described herein. The LODES system 1104 may be electrically connected to a wind farm 1102 and one or more transmission facilities 1106. The wind farm 1102 may be electrically connected to the transmission facilities 1106. The transmission facilities 1106 may be electrically connected to the grid 1108. The wind farm 1102 may generate power and the wind farm 1102 may output generated power to the LODES system 1104 and/or the transmission facilities 1106. The LODES system 1104 may store power received from the wind farm 1102 and/or the transmission facilities 1106. The LODES system 1104 may output stored power to the transmission facilities 1106. The transmission facilities 1106 may output power received from one or both of the wind farm 1102 and LODES system 1104 to the grid 1108 and/or may receive power from the grid 1108 and output that power to the LODES system 1104. Together the wind farm 1102, the LODES system 1104, and the transmission facilities 1106 may constitute a power plant 1100 that may be a combined power generation, transmission, and storage system. The power generated by the wind farm 1102 may be directly fed to the grid 1108 through the transmission facilities 1106, or may be first stored in the LODES system 1104. In certain cases the power supplied to the grid 1108 may come entirely from the wind farm 1102, entirely from the LODES system 1104, or from a combination of the wind farm 1102 and the LODES system 1104. The dispatch of power from the combined wind farm 1102 and LODES system 1104 power plant 1100 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 1100, the LODES system 1104 may be used to reshape and “firm” the power produced by the wind farm 1102. In one such example, the wind farm 1102 may have a peak generation output (capacity) of 260 megawatts (MW) and a capacity factor (CF) of 41%. The LODES system 1104 may have a power rating (capacity) of 106 MW, a rated duration (energy/power ratio) of 150 hours (h), and an energy rating of 15,900 megawatt hours (MWh). In another such example, the wind farm 1102 may have a peak generation output (capacity) of 300 MW and a capacity factor (CF) of 41%. The LODES system 1104 may have a power rating of 106 MW, a rated duration (energy/power ratio) of 200 h and an energy rating of 21,200 MWh. In another such example, the wind farm 1102 may have a peak generation output (capacity) of 176 MW and a capacity factor (CF) of 53%. The LODES system 1104 may have a power rating (capacity) of 88 MW, a rated duration (energy/power ratio) of 150 h and an energy rating of 13,200 MWh. In another such example, the wind farm 1102 may have a peak generation output (capacity) of 277 MW and a capacity factor (CF) of 41%. The LODES system 1104 may have a power rating (capacity) of 97 MW, a rated duration (energy/power ratio) of 50 h and an energy rating of 4,850 MWh. In another such example, the wind farm 1102 may have a peak generation output (capacity) of 315 MW and a capacity factor (CF) of 41%. The LODES system 1104 may have a power rating (capacity) of 110 MW, a rated duration (energy/power ratio) of 25 h and an energy rating of 2,750 MWh.

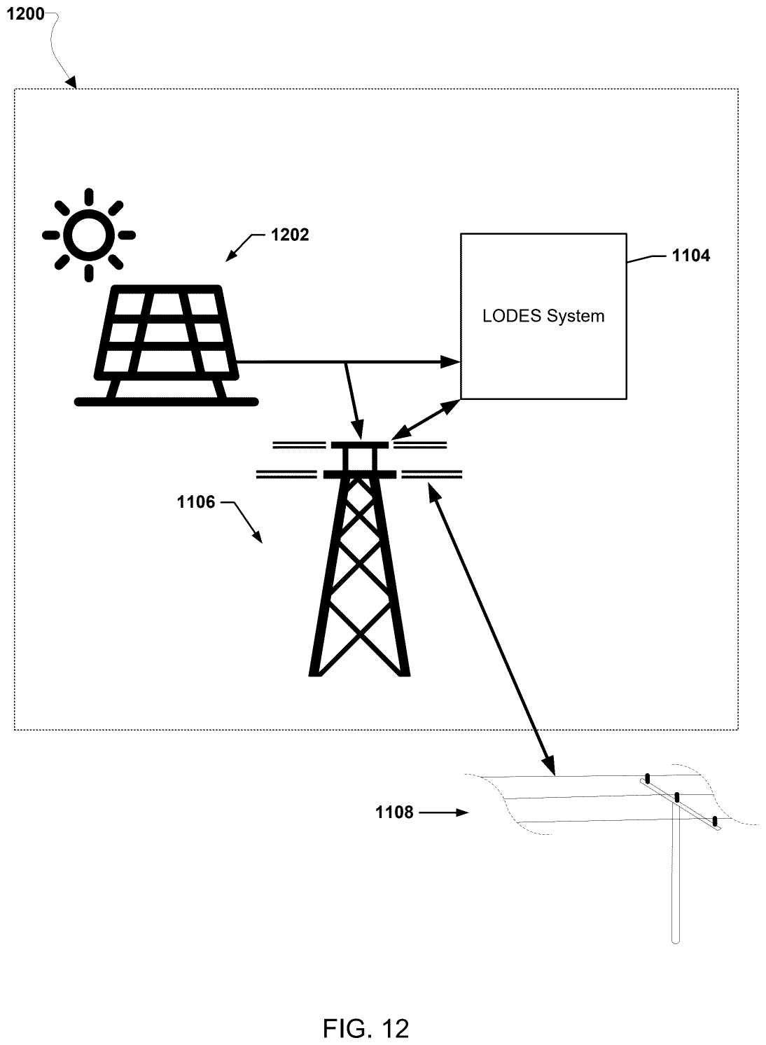

FIG. 12 illustrates an example system in which one or more aspects of the various embodiments may be used as part of bulk energy storage system. As a specific example, the bulk energy storage system incorporating one or more aspects of the various embodiments may be a LODES system 1104. As an example, the LODES system 1104 may include various embodiment batteries described herein (e.g., batteries 100, 200, 500, 600, 700, 800, 900, 1000, etc.) and/or various one or more battery components, singularly or in various combinations, such as electrodes, leads, pumps, mechanical barriers, current collectors, bladders, lifting systems, etc., as described herein. The system of FIG. 12 may be similar to the system of FIG. 11, except a photovoltaic (PV) farm 1202 may be substituted for the wind farm 1102. The LODES system 1104 may be electrically connected to the PV farm 1202 and one or more transmission facilities 1106. The PV farm 1202 may be electrically connected to the transmission facilities 1106. The transmission facilities 1106 may be electrically connected to the grid 1108. The PV farm 1202 may generate power and the PV farm 1202 may output generated power to the LODES system 1104 and/or the transmission facilities 1106. The LODES system 1104 may store power received from the PV farm 1202 and/or the transmission facilities 1106. The LODES system 1104 may output stored power to the transmission facilities 1106. The transmission facilities 1106 may output power received from one or both of the PV farm 1202 and LODES system 1104 to the grid 1108 and/or may receive power from the grid 1108 and output that power to the LODES system 1104. Together the PV farm 1202, the LODES system 1104, and the transmission facilities 1106 may constitute a power plant 1200 that may be a combined power generation, transmission, and storage system. The power generated by the PV farm 1202 may be directly fed to the grid 1108 through the transmission facilities 1106, or may be first stored in the LODES system 1104. In certain cases the power supplied to the grid 1108 may come entirely from the PV farm 1202, entirely from the LODES system 1104, or from a combination of the PV farm 1202 and the LODES system 1104. The dispatch of power from the combined PV farm 1202 and LODES system 1104 power plant 1200 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 1200, the LODES system 1104 may be used to reshape and “firm” the power produced by the PV farm 1202. In one such example, the PV farm 1202 may have a peak generation output (capacity) of 490 MW and a capacity factor (CF) of 24%. The LODES system 1104 may have a power rating (capacity) of 340 MW, a rated duration (energy/power ratio) of 150 h and an energy rating of 51,000 MWh. In another such example, the PV farm 1202 may have a peak generation output (capacity) of 680 MW and a capacity factor (CF) of 24%. The LODES system 1104 may have a power rating (capacity) of 410 MW, a rated duration (energy/power ratio) of 200 h, and an energy rating of 82,000 MWh. In another such example, the PV farm 1202 may have a peak generation output (capacity) of 330 MW and a capacity factor (CF) of 31%. The LODES system 1104 may have a power rating (capacity) of 215 MW, a rated duration (energy/power ratio) of 150 h, and an energy rating of 32,250 MWh. In another such example, the PV farm 1202 may have a peak generation output (capacity) of 510 MW and a capacity factor (CF) of 24%. The LODES system 1104 may have a power rating (capacity) of 380 MW, a rated duration (energy/power ratio) of 50 h, and an energy rating of 19,000 MWh. In another such example, the PV farm 1202 may have a peak generation output (capacity) of 630 MW and a capacity factor (CF) of 24%. The LODES system 1104 may have a power rating (capacity) of 380 MW, a rated duration (energy/power ratio) of 25 h, and an energy rating of 9,500 MWh.

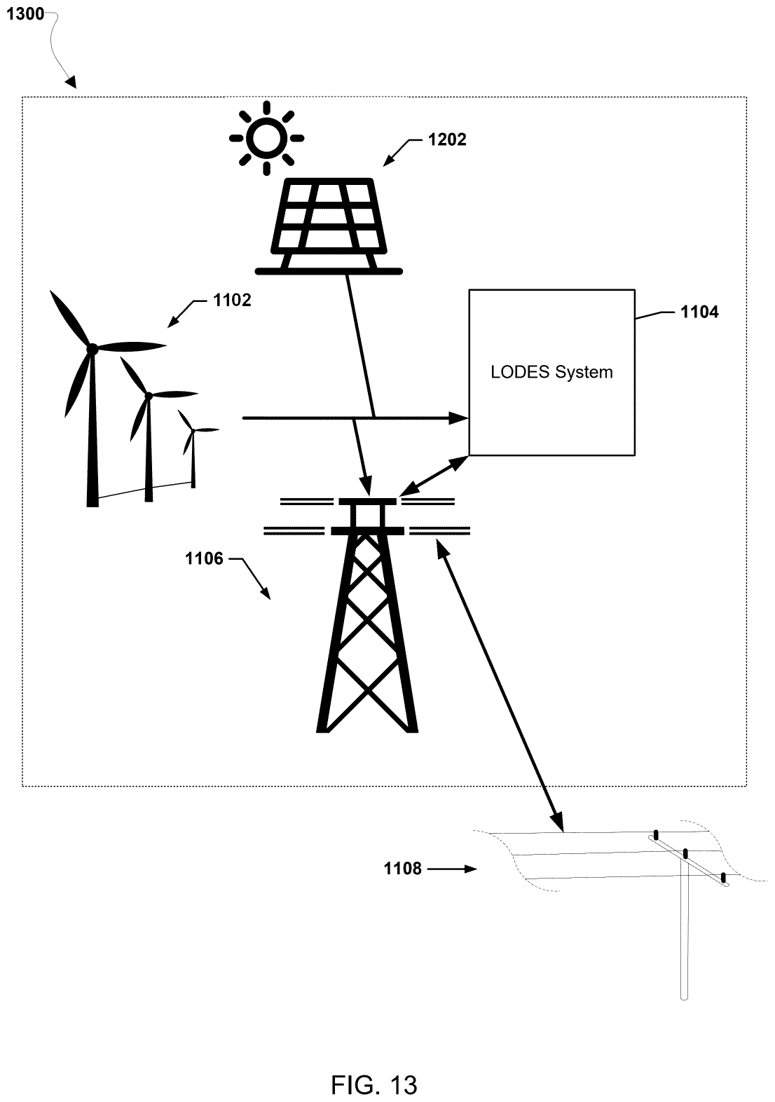

FIG. 13 illustrates an example system in which one or more aspects of the various embodiments may be used as part of bulk energy storage system. As a specific example, the bulk energy storage system incorporating one or more aspects of the various embodiments may be a LODES system 1104. As an example, the LODES system 1104 may include various embodiment batteries described herein (e.g., batteries 100, 200, 500, 600, 700, 800, 900, 1000, etc.) and/or various one or more battery components, singularly or in various combinations, such as electrodes, leads, pumps, mechanical barriers, current collectors, bladders, lifting systems, etc., as described herein. The system of FIG. 13 may be similar to the systems of FIGS. 11 and 12, except the wind farm 1102 and the photovoltaic (PV) farm 1202 may both be power generators working together in the power plant 1300. Together the PV farm 1202, wind farm 1102, the LODES system 1104, and the transmission facilities 1106 may constitute the power plant 1300 that may be a combined power generation, transmission, and storage system. The power generated by the PV farm 1202 and/or the wind farm 1102 may be directly fed to the grid 1108 through the transmission facilities 1106, or may be first stored in the LODES system 1104. In certain cases the power supplied to the grid 1108 may come entirely from the PV farm 1202, entirely from the wind farm 1102, entirely from the LODES system 1104, or from a combination of the PV farm 1202, the wind farm 1102, and the LODES system 1104. The dispatch of power from the combined wind farm 1102, PV farm 1202, and LODES system 1104 power plant 1300 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 1300, the LODES system 1104 may be used to reshape and “firm” the power produced by the wind farm 1102 and the PV farm 1202. In one such example, the wind farm 1102 may have a peak generation output (capacity) of 126 MW and a capacity factor (CF) of 41% and the PV farm 1202 may have a peak generation output (capacity) of 126 MW and a capacity factor (CF) of 24%. The LODES system 1104 may have a power rating (capacity) of 63 MW, a rated duration (energy/power ratio) of 150 h, and an energy rating of 9,450 MWh. In another such example, the wind farm 1102 may have a peak generation output (capacity) of 170 MW and a capacity factor (CF) of 41% and the PV farm 1202 may have a peak generation output (capacity) of 110 MW and a capacity factor (CF) of 24%. The LODES system 1104 may have a power rating (capacity) of 57 MW, a rated duration (energy/power ratio) of 200 h, and an energy rating of 11,400 MWh. In another such example, the wind farm 1102 may have a peak generation output (capacity) of 105 MW and a capacity factor (CF) of 51% and the PV farm 1202 may have a peak generation output (capacity) of 70 MW and a capacity factor (CF) of 31 The LODES system 1104 may have a power rating (capacity) of 61 MW, a rated duration (energy/power ratio) of 150 h, and an energy rating of 9,150 MWh. In another such example, the wind farm 1102 may have a peak generation output (capacity) of 135 MW and a capacity factor (CF) of 41% and the PV farm 1202 may have a peak generation output (capacity) of 90 MW and a capacity factor (CF) of 24%. The LODES system 1104 may have a power rating (capacity) of 68 MW, a rated duration (energy/power ratio) of 50 h, and an energy rating of 3,400 MWh. In another such example, the wind farm 1102 may have a peak generation output (capacity) of 144 MW and a capacity factor (CF) of 41% and the PV farm 1202 may have a peak generation output (capacity) of 96 MW and a capacity factor (CF) of 24%. The LODES system 1104 may have a power rating (capacity) of 72 MW, a rated duration (energy/power ratio) of 25 h, and an energy rating of 1,800 MWh.

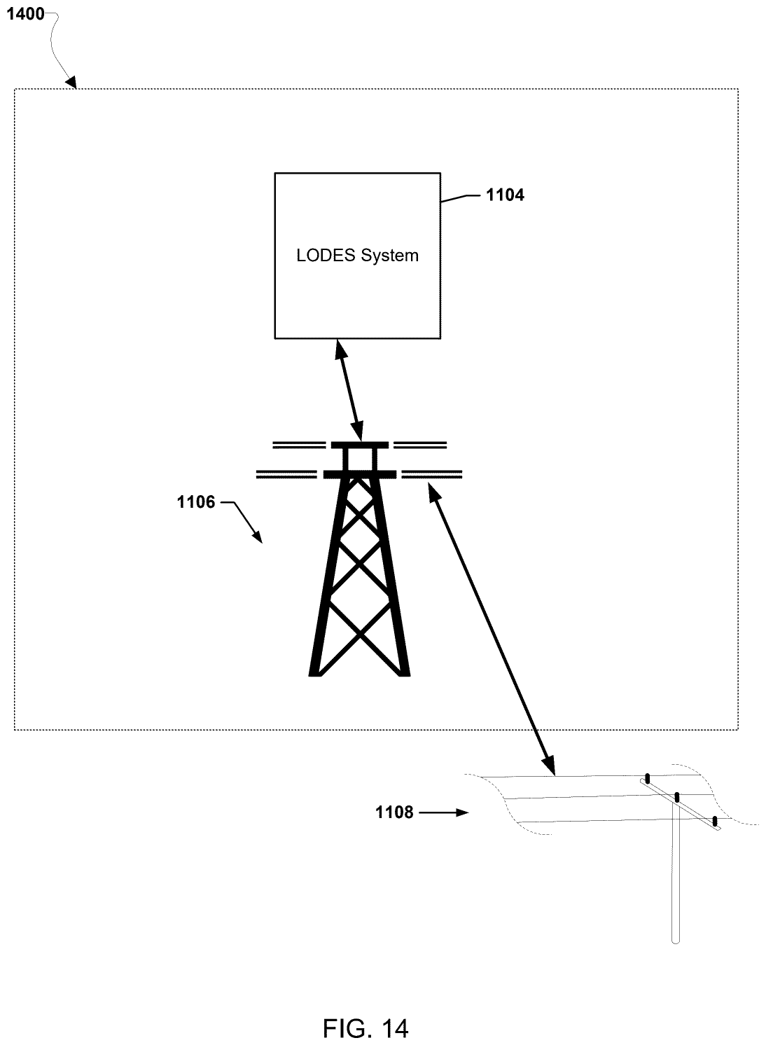

FIG. 14 illustrates an example system in which one or more aspects of the various embodiments may be used as part of bulk energy storage system. As a specific example, the bulk energy storage system incorporating one or more aspects of the various embodiments may be a LODES system 1104. As an example, the LODES system 1104 may include various embodiment batteries described herein (e.g., batteries 100, 200, 500, 600, 700, 800, 900, 1000, etc.) and/or various one or more battery components, singularly or in various combinations, such as electrodes, leads, pumps, mechanical barriers, current collectors, bladders, lifting systems, etc., as described herein. The LODES system 1104 may be electrically connected to one or more transmission facilities 1106. In this manner, the LODES system 1104 may operate in a “stand-alone” manner to arbiter energy around market prices and/or to avoid transmission constraints. The LODES system 1104 may be electrically connected to one or more transmission facilities 1106. The transmission facilities 1106 may be electrically connected to the grid 1108. The LODES system 1104 may store power received from the transmission facilities 1106. The LODES system 1104 may output stored power to the transmission facilities 1106. The transmission facilities 1106 may output power received from the LODES system 1104 to the grid 1108 and/or may receive power from the grid 1108 and output that power to the LODES system 1104.

Together the LODES system 1104 and the transmission facilities 1106 may constitute a power plant 1400. As an example, the power plant 1400 may be situated downstream of a transmission constraint, close to electrical consumption. In such an example downstream situated power plant 1400, the LODES system 1104 may have a duration of 24 h to 500 h and may undergo one or more full discharges a year to support peak electrical consumptions at times when the transmission capacity is not sufficient to serve customers. Additionally, in such an example downstream situated power plant 1400, the LODES system 1104 may undergo several shallow discharges (daily or at higher frequency) to arbiter the difference between nighttime and daytime electricity prices and reduce the overall cost of electrical service to customer. As a further example, the power plant 1400 may be situated upstream of a transmission constraint, close to electrical generation. In such an example upstream situated power plant 1400, the LODES system 1104 may have a duration of 24 h to 500 h and may undergo one or more full charges a year to absorb excess generation at times when the transmission capacity is not sufficient to distribute the electricity to customers. Additionally, in such an example upstream situated power plant 1400, the LODES system 1104 may undergo several shallow charges and discharges (daily or at higher frequency) to arbiter the difference between nighttime and daytime electricity prices and maximize the value of the output of the generation facilities.

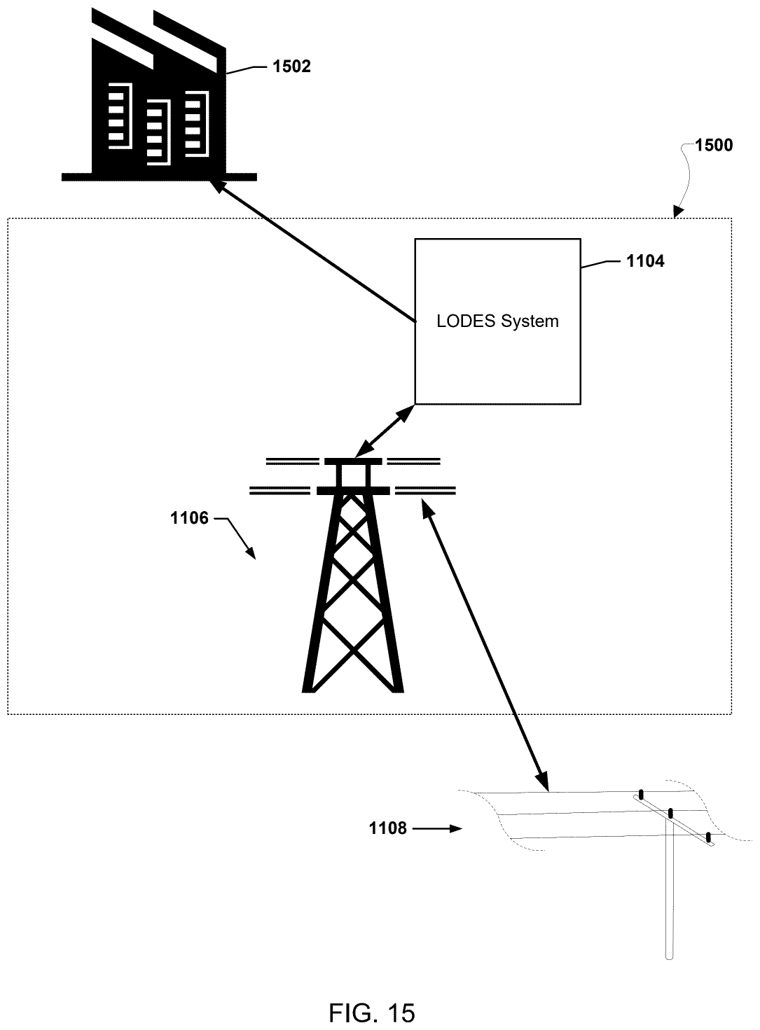

FIG. 15 illustrates an example system in which one or more aspects of the various embodiments may be used as part of bulk energy storage system. As a specific example, the bulk energy storage system incorporating one or more aspects of the various embodiments may be a LODES system 1104. As an example, the LODES system 1104 may include various embodiment batteries described herein (e.g., batteries 100, 200, 500, 600, 700, 800, 900, 1000, etc.) and/or various one or more battery components, singularly or in various combinations, such as electrodes, leads, pumps, mechanical barriers, current collectors, bladders, lifting systems, etc., as described herein. The LODES system 1104 may be electrically connected to a commercial and industrial (C&I) customer 1502, such as a data center, factory, etc. The LODES system 1104 may be electrically connected to one or more transmission facilities 1106. The transmission facilities 1106 may be electrically connected to the grid 1108. The transmission facilities 1106 may receive power from the grid 1108 and output that power to the LODES system 1104. The LODES system 1104 may store power received from the transmission facilities 1106. The LODES system 1104 may output stored power to the C&I customer 1502. In this manner, the LODES system 1104 may operate to reshape electricity purchased from the grid 1108 to match the consumption pattern of the C&I customer 1502.

Together, the LODES system 1104 and transmission facilities 1106 may constitute a power plant 1500. As an example, the power plant 1500 may be situated close to electrical consumption, i.e., close to the C&I customer 1502, such as between the grid 1108 and the C&I customer 1502. In such an example, the LODES system 1104 may have a duration of 24 h to 500 h and may buy electricity from the markets and thereby charge the LODES system 1104 at times when the electricity is cheaper. The LODES system 1104 may then discharge to provide the C&I customer 1502 with electricity at times when the market price is expensive, therefore offsetting the market purchases of the C&I customer 1502. As an alternative configuration, rather than being situated between the grid 1108 and the C&I customer 1502, the power plant 1500 may be situated between a renewable source, such as a PV farm, wind farm, etc., and the transmission facilities 1106 may connect to the renewable source. In such an alternative example, the LODES system 1104 may have a duration of 24 h to 500 h, and the LODES system 1104 may charge at times when renewable output may be available. The LODES system 1104 may then discharge to provide the C&I customer 1502 with renewable generated electricity so as to cover a portion, or the entirety, of the C&I customer 1502 electricity needs.

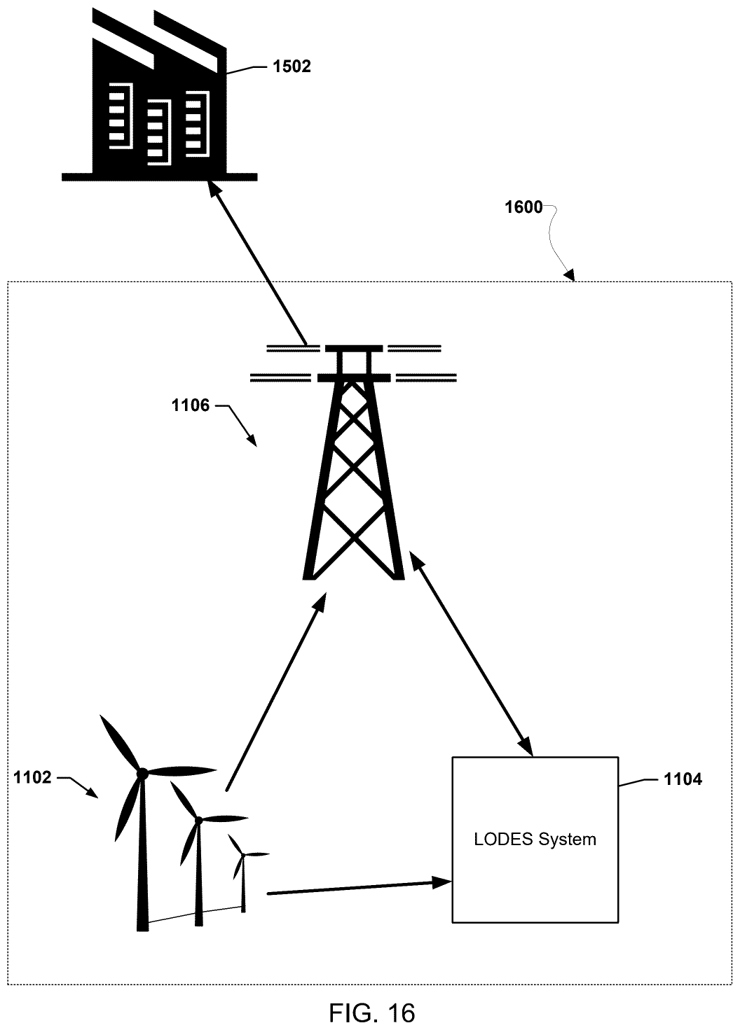

FIG. 16 illustrates an example system in which one or more aspects of the various embodiments may be used as part of bulk energy storage system. As a specific example, the bulk energy storage system incorporating one or more aspects of the various embodiments may be a LODES system 1104. As an example, the LODES system 1104 may include various embodiment batteries described herein (e.g., batteries 100, 200, 500, 600, 700, 800, 900, 1000, etc.) and/or various one or more battery components, singularly or in various combinations, such as electrodes, leads, pumps, mechanical barriers, current collectors, bladders, lifting systems, etc., as described herein. The LODES system 1104 may be electrically connected to a wind farm 1102 and one or more transmission facilities 1106. The wind farm 1102 may be electrically connected to the transmission facilities 1106. The transmission facilities 1106 may be electrically connected to a C&I customer 1502. The wind farm 1102 may generate power and the wind farm 1102 may output generated power to the LODES system 1104 and/or the transmission facilities 1106. The LODES system 1104 may store power received from the wind farm 1102. The LODES system 1104 may output stored power to the transmission facilities 1106. The transmission facilities 1106 may output power received from one or both of the wind farm 1102 and LODES system 1104 to the C&I customer 1502. Together the wind farm 1102, the LODES system 1104, and the transmission facilities 1106 may constitute a power plant 1600 that may be a combined power generation, transmission, and storage system. The power generated by the wind farm 1102 may be directly fed to the C&I customer 1502 through the transmission facilities 1106, or may be first stored in the LODES system 1104. In certain cases the power supplied to the C&I customer 1502 may come entirely from the wind farm 1102, entirely from the LODES system 1104, or from a combination of the wind farm 1102 and the LODES system 1104. The LODES system 1104 may be used to reshape the electricity generated by the wind farm 1102 to match the consumption pattern of the C&I customer 1502. In one such example, the LODES system 1104 may have a duration of 24 h to 500 h and may charge when renewable generation by the wind farm 1102 exceeds the C&I customer 1502 load. The LODES system 1104 may then discharge when renewable generation by the wind farm 1102 falls short of C&I customer 1502 load so as to provide the C&I customer 1502 with a firm renewable profile that offsets a fraction, or all of, the C&I customer 1502 electrical consumption.

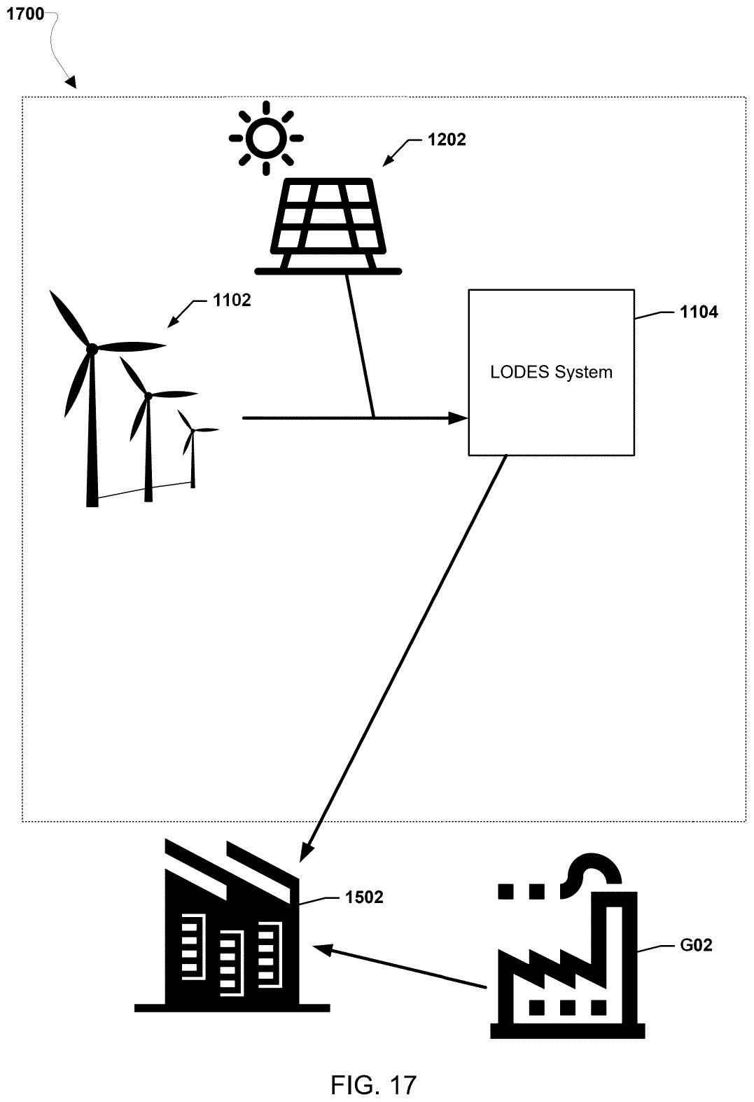

FIG. 17 illustrates an example system in which one or more aspects of the various embodiments may be used as part of bulk energy storage system. As a specific example, the bulk energy storage system incorporating one or more aspects of the various embodiments may be a LODES system 1104. As an example, the LODES system 1104 may include various embodiment batteries described herein (e.g., batteries 100, 200, 500, 600, 700, 800, 900, 1000, etc.) and/or various one or more battery components, singularly or in various combinations, such as electrodes, leads, pumps, mechanical barriers, current collectors, bladders, lifting systems, etc., as described herein. The LODES system 1104 may be part of a power plant 1700 that is used to integrate large amounts of renewable generation in microgrids and harmonize the output of renewable generation by, for example a PV farm 1202 and wind farm 1102, with existing thermal generation by, for example a thermal power plant 1702 (e.g., a gas plant, a coal plant, a diesel generator set, etc., or a combination of thermal generation methods), while renewable generation and thermal generation supply the C&I customer 1502 load at high availability. Microgrids, such as the microgrid constituted by the power plant 1700 and the thermal power plant 1702, may provide availability that is 90% or higher. The power generated by the PV farm 1202 and/or the wind farm 1102 may be directly fed to the C&I customer 1502, or may be first stored in the LODES system 1104. In certain cases the power supplied to the C&I customer 1502 may come entirely from the PV farm 1202, entirely from the wind farm 1102, entirely from the LODES system 1104, entirely from the thermal power plant 1702, or from any combination of the PV farm 1202, the wind farm 1102, the LODES system 1104, and/or the thermal power plant 1702. As examples, the LODES system 1104 of the power plant 1700 may have a duration of 24 h to 500 h. As a specific example, the C&I customer 1502 load may have a peak of 100 MW, the LODES system 1104 may have a power rating of 14 MW and duration of 150 h, natural gas may cost $6/million British thermal units (MMBTU), and the renewable penetration may be 58%. As another specific example, the C&I customer 1502 load may have a peak of 100 MW, the LODES system 1104 may have a power rating of 25 MW and duration of 150 h, natural gas may cost $8/MMBTU, and the renewable penetration may be 65%.

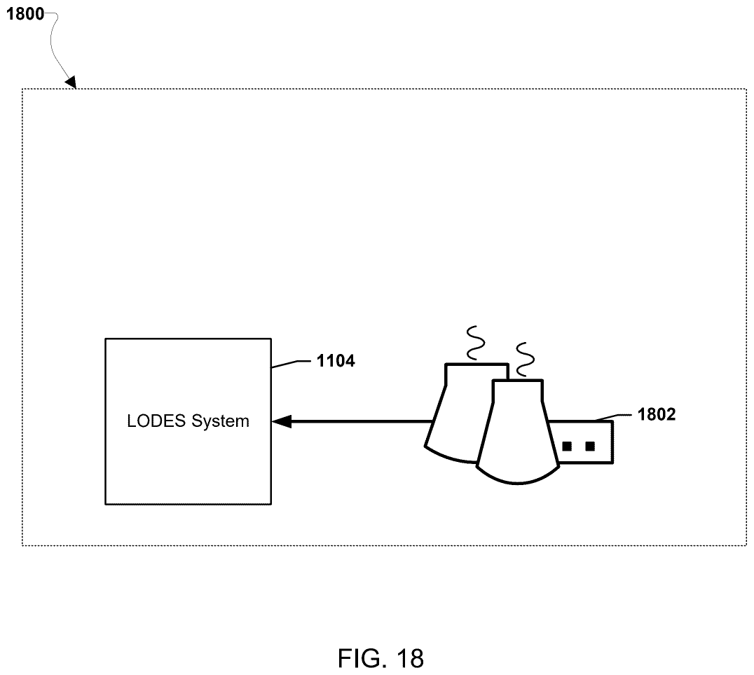

FIG. 18 illustrates an example system in which one or more aspects of the various embodiments may be used as part of bulk energy storage system. As a specific example, the bulk energy storage system incorporating one or more aspects of the various embodiments may be a LODES system 1104. As an example, the LODES system 1104 may include various embodiment batteries described herein (e.g., batteries 100, 200, 500, 600, 700, 800, 900, 1000, etc.) and/or various one or more battery components, singularly or in various combinations, such as electrodes, leads, pumps, mechanical barriers, current collectors, bladders, lifting systems, etc., as described herein. The LODES system 1104 may be used to augment a nuclear plant 1802 (or other inflexible generation facility, such as a thermal, a biomass, etc., and/or any other type plant having a ramp-rate lower than 50% of rated power in one hour and a high capacity factor of 80% or higher) to add flexibility to the combined output of the power plant 1800 constituted by the combined LODES system 1104 and nuclear plant 1802. The nuclear plant 1802 may operate at high capacity factor and at the highest efficiency point, while the LODES system 1104 may charge and discharge to effectively reshape the output of the nuclear plant 1802 to match a customer electrical consumption and/or a market price of electricity. As examples, the LODES system 1104 of the power plant 1800 may have a duration of 24 h to 500 h. In one specific example, the nuclear plant 1802 may have 1,000 MW of rated output and the nuclear plant 1802 may be forced into prolonged periods of minimum stable generation or even shutdowns because of depressed market pricing of electricity. The LODES system 1104 may avoid facility shutdowns and charge at times of depressed market pricing; and the LODES system 1104 may subsequently discharge and boost total output generation at times of inflated market pricing.

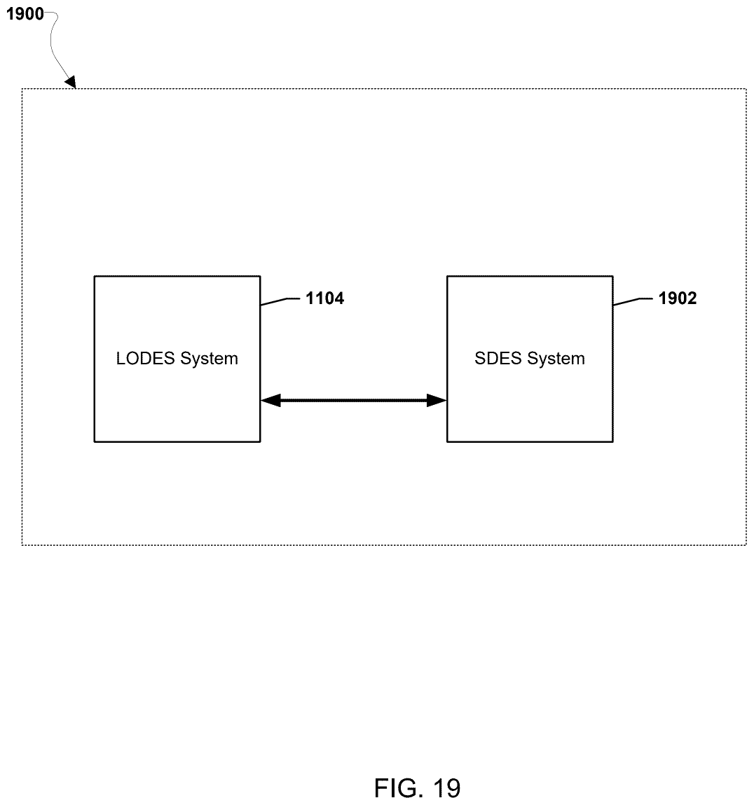

FIG. 19 illustrates an example system in which one or more aspects of the various embodiments may be used as part of bulk energy storage system. As a specific example, the bulk energy storage system incorporating one or more aspects of the various embodiments may be a LODES system 1104. As an example, the LODES system 1104 may include various embodiment batteries described herein (e.g., batteries 100, 200, 500, 600, 700, 800, 900, 1000, etc.) and/or various one or more battery components, singularly or in various combinations, such as electrodes, leads, pumps, mechanical barriers, current collectors, bladders, lifting systems, etc., as described herein. The LODES system 1104 may operate in tandem with a SDES system 1902. Together the LODES system 1104 and SDES system 1902 may constitute a power plant 1900. As an example, the LODES system 1104 and SDES system 1902 may be co-optimized whereby the LODES system 1104 may provide various services, including long-duration back-up and/or bridging through multi-day fluctuations (e.g., multi-day fluctuations in market pricing, renewable generation, electrical consumption, etc.), and the SDES system 1902 may provide various services, including fast ancillary services (e.g. voltage control, frequency regulation, etc.) and/or bridging through intra-day fluctuations (e.g., intra-day fluctuations in market pricing, renewable generation, electrical consumption, etc.). The SDES system 1902 may have durations of less than 10 hours and round-trip efficiencies of greater than 80%. The LODES system 1104 may have durations of 24 h to 500 h and round-trip efficiencies of greater than 40% In one such example, the LODES system 1104 may have a duration of 150 hours and support customer electrical consumption for up to a week of renewable under-generation. The LODES system 1104 may also support customer electrical consumption during intra-day under-generation events, augmenting the capabilities of the SDES system 1902. Further, the SDES system 1902 may supply customers during intra-day under-generation events and provide power conditioning and quality services such as voltage control and frequency regulation.

In applying performance metrics, such as round-trip efficiency, etc., to a LODES or an SDES, the values for the metrics are based upon the average values of the stacks, cells or components making up the LODES or SDES, unless such values can be directly calculated.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

Further, any step of any embodiment described herein can be used in any other embodiment. The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

What is claimed is:

1. A battery comprising:
a vessel;
an air electrode;
a metal electrode;
a current collector supporting the metal electrode within the vessel;
an electrolyte within a portion of the vessel; and
a pump fluidically coupled to the vessel, the pump actuatable to pump the electrolyte into the vessel to a first level submerging the metal electrode, and the pump actuatable to pump the electrolyte out of the vessel to a second level removing the metal electrode from the electrolyte.

2. The battery of claim 1, wherein the current collector is rigid and porous.

3. The battery of claim 1, wherein the metal electrode includes iron or an iron-alloy.

4. A battery comprising:
a vessel;
an air electrode;
a metal electrode;
a current collector supporting the metal electrode within the vessel;
an electrolyte within a portion of the vessel; and
a bladder inflatable to a first size displacing the electrolyte in the vessel such that the metal electrode is submerged in the electrolyte when the bladder, the bladder inflatable to a second size removing the electrolyte from contact with the metal electrode in the vessel.

5. The battery of claim 4, wherein the bladder is an air bladder.

6. The battery of claim 4, wherein the metal electrode is comprised of iron or an iron-alloy.

7. A battery comprising:
a vessel;
an air electrode;
a metal electrode;
a current collector supporting the metal electrode and the air electrode within the vessel;
an electrolyte within a portion of the vessel; and
a lifting system coupled to the current collector, the lifting system actuatable to raise and lower the metal electrode out of and into the electrolyte in the vessel.

8. The battery of claim 7, wherein the lifting system includes one or more motors and one or more drive elements coupled to the one or more motors.

9. The battery of claim 7, wherein the metal electrode includes iron or an iron-alloy.

10. A battery comprising:
an anode;
a first cathode;
a second cathode; and
an electrolyte, the electrolyte flooding a first surface of the first cathode, a second surface of the second cathode, and a third surface of the anode when the battery is operating in a discharge mode, and the electrolyte spaced apart from contact with the second cathode when the battery is operating in a recharge mode.

11. The battery of claim 10, wherein the first cathode is operable to evolve oxygen in the recharge mode of the battery and to reduce oxygen in the discharge mode of the battery.

12. The battery of claim 11, wherein the anode includes iron or an iron-alloy.

13. The battery of claim 11, wherein the first cathode comprises a hydrophilic portion and a hydrophobic portion.

14. The battery of claim 13, wherein the second surface of the second cathode is hydrophilic.

15. The battery of claim 14, wherein the second cathode includes a substrate coated with nickel.

16. The battery of claim 15, wherein the substrate comprises carbon, titanium, or copper.

17. The battery of claim 10, wherein the anode includes iron ore in a form comprising taconite, magnetite, or hematite, reduced iron ore comprising iron metal (Fe0), wustite (FeO), or a mixture thereof.

18. The battery of claim 10, wherein the anode includes reduced taconite, direct reduced (“DR”) taconite, not-yet-reduced “DR Grade” taconite, direct reduced iron (“DRI”), or any combination thereof.
